(19) United States
(12) Patent Application Publication
(10) Pub. No.: US 2006/0170962 A1
(43) Pub. Date: Aug. 3, 2006

(54) Image processing apparatus, log management method, and log management system

(75) Inventor: Takashi Nakamura, Kanagawa (JP)

Correspondence Address: HARNESS, DICKEY & PIERCE, P.L.C., P.O. BOX 8910, RESTON, VA, 20195, US

(73) Assignee: Ricoh Company, Ltd.

(21) Appl. No.: 11/340,702

(22) Filed: Jan. 27, 2006

(30) Foreign Application Priority Data
Jan. 31, 2005 (JP) 2005-024189

(51) Int. Cl. G06F 3/12

(52) U.S. Cl. 358/1.15

(57) ABSTRACT

An image processing apparatus for performing an image forming process is disclosed. The image processing apparatus includes one or more job executing parts for executing a series of jobs for performing the image forming process, and a log recording part for recording a plurality of log information items corresponding to the series of jobs executed by the one or more job executing parts. The plural log information items are recorded in association with the image forming process.

### BACKGROUND OF THE INVENTION

1. Field of the Invention

The present invention relates to an image processing apparatus, a log management method, and a log management system, and more particularly to an image processing apparatus, a log management method, and a log management system for recording log information.

2. Description of the Related Art

Recent image processing apparatuses are known to have the functions of multiple apparatuses such as printers, copy machines, facsimile machines, and scanners, included in a single housing thereof. The image processing apparatus has, for example, a plotter, and a scanner as well as software corresponding to various apparatuses such as printers, copy machines, facsimile machines, and scanners included in its housing. The image processing apparatus performs the functions of the various apparatuses such as printers, copy machines, facsimile machines, and scanners by switching software (For example, Japanese Laid-Open Patent Application No. 2003-341175).

The image processing apparatus performs operations (e.g. outputting, changing, and transferring an image) in units referred to as “jobs”. For example, in a process of copying a document, the operation includes an operation of reading the document and an operation of printing the read document. Therefore, a document reading job and a document printing job are generated in the copying process.

In a conventional image processing apparatus, once the image processing apparatus completes a job, the job is recorded in its own history or in a history in another apparatus. For example, Japanese Laid-Open Patent Application No. 2000-132357 discloses an apparatus that records jobs in its history. Furthermore, Japanese Laid-Open Application No. 2004-102549 discloses a copy machine that transfers history to a copy server and has the history recorded thereby.

For example, in a case of performing an image forming process (e.g. a copying process), the image forming process is achieved by a series of jobs including, for example, a document reading job and a printing job. In a conventional image processing apparatus, after the image processing apparatus completes a job, the history corresponding to the completed job is recorded as log information in job units. Meanwhile, the operator operates the image processing apparatus in process units.

Accordingly, since the conventional image processing apparatus records log information in job units, the image processing apparatus is unable to determine which of the log information items corresponds to a single operation (process) conducted by the operator. Furthermore, since the operator operates the image processing apparatus in process units, the operator is unable to distinguish which one(s) of the log information resulted from the single operation requested by the operator.

### SUMMARY OF THE INVENTION

It is a general object of the present invention to provide an image processing apparatus, a log management method, and a log management system that substantially obviate one or more of the problems caused by the limitations and disadvantages of the related art.

Features and advantages of the present invention will be set forth in the description which follows, and in part will become apparent from the description and the accompanying drawings, or may be learned by practice of the invention according to the teachings provided in the description. Objects as well as other features and advantages of the present invention will be realized and attained by an image processing apparatus, a log management method, and a log management system particularly pointed out in the specification in such full, clear, concise, and exact terms as to enable a person having ordinary skill in the art to practice the invention.

To achieve these and other advantages and in accordance with the purpose of the invention, as embodied and broadly described herein, an embodiment of the present invention provides an image processing apparatus for performing an image forming process, the image processing apparatus including: one or more job executing parts for executing a series of jobs for performing the image forming process; and a log recording part for recording a plurality of log information items corresponding to the series of jobs executed by the one or more job executing parts; wherein the plural log information items are recorded in association with the image forming process.

Furthermore, an embodiment of the present invention provides an image processing apparatus for performing an image forming process, the image processing apparatus including: one or more job executing parts for executing a series of jobs for performing the image forming process; and a log recording part for receiving a plurality of log information items corresponding to the series of jobs from the one or more job executing parts, binding together the plural log information items, and recording the bound plural log information items in association with the image forming process.

Furthermore, an embodiment of the present invention provides an image processing apparatus for performing an image forming process, the image processing apparatus including: one or more job executing parts for executing a series of jobs for performing the image forming process; a log recording part for receiving a plurality of log information items corresponding to the series of jobs from the one or more job executing parts, binding together the plurality of log information items, and recording the bound plural log information items in association with the image forming process; and a log integration part for requesting the log recording part to bind together the plural log information items and record the bound plural log information items in association with the image forming process.

Furthermore, an embodiment of the present invention provides an image processing apparatus for performing an image forming process, the image processing apparatus including: a job executing part for executing a series of jobs for performing the image forming process and binding together a plurality of log information items corresponding to the series of jobs; and a log recording part for receiving the bound plural log information items from the job executing part and recording the bound plural log information items.

Furthermore, an embodiment of the present invention provides an image processing apparatus for performing an image forming process, the image processing apparatus including: one or more job executing parts for executing a series of jobs for performing the image forming process; a log integration part for receiving a plurality of log information items corresponding to the series of jobs from the one or more job executing parts and binding together the plural log information items; and a log recording part for receiving the bound plural log information items from the log integration part and recording the bound plural log information items.

Furthermore, an embodiment of the present invention provides an image processing apparatus for performing an image forming process, the image processing apparatus including: one or more job executing parts for executing a series of jobs for performing the image forming process; a log integration part for receiving a plurality of log information items corresponding to the series of jobs from the one or more job executing parts and making a request to bind together the plural log information items and transfer the bound plural log information items; a log recording part for receiving the plural log information items from the log integration part and recording the plural log information items; and a log transferring part for binding together the plural log information items in accordance with the request of the log integration part and transferring the bound plural log information items to a predetermined log management apparatus.

Furthermore, an embodiment of the present invention provides an image processing apparatus connected to a terminal that is operated by an operator and a log management apparatus that manages log information, the image processing apparatus being connected to the terminal and the log management apparatus via a predetermined network, the image processing apparatus including: a receiving part for receiving a request to perform an image forming process from the terminal; one or more job executing parts for executing a series of jobs for performing the image forming process; and a transferring part for transferring a plurality of log information items corresponding to the series of jobs to the log management apparatus; wherein the plural log information items are transferred in association with the image forming process.

Furthermore, an embodiment of the present invention provides a log management method for an image processing apparatus performing an image forming process, the method including the steps of: executing a series of jobs for performing the image forming process; and recording a plurality of log information items corresponding to the series of jobs in association with the image forming process.

Furthermore, an embodiment of the present invention provides a log management system including an image processing apparatus connected to a terminal that is operated by an operator and a log management apparatus that manages log information, the image processing apparatus being connected to the terminal and the log management apparatus via a predetermined network, the image processing apparatus including: a receiving part for receiving a request to perform an image forming process from the terminal; one or more job executing parts for executing a series of jobs for performing the image forming process; and a transferring part for transferring a plurality of log information items corresponding to the series of jobs to the log management apparatus; wherein the plural log information items are transferred in association with the image forming process.

Other objects and further features of the present invention will be apparent from the following detailed description when read in conjunction with the accompanying drawings.

### BRIEF DESCRIPTION OF THE DRAWINGS

FIG. 1 is a schematic diagram showing an example of a hardware configuration of a MFP according to an embodiment of the present invention;

FIG. 2 is a schematic diagram showing an example of a log management system according to an embodiment of the present invention;

FIG. 3 is a sequence diagram showing an operation (process) of a log management system according to an embodiment of the present invention;

FIG. 4 is a schematic diagram showing an exemplary configuration of bound log information according to an embodiment of the present invention;

FIG. 5 is a schematic diagram showing an exemplary configuration of XML data in a case of transferring bound log information to a server according to an embodiment of the present invention;

FIG. 6 is a sequence diagram showing another operation (process) of a log management system according to an embodiment of the present invention;

FIG. 7 is a schematic diagram showing an exemplary configuration of log information that is not bound according to an embodiment of the present invention;

FIG. 8 is a schematic diagram showing an exemplary configuration of XML data in a case of transferring log information (not bound) to a server according to an embodiment of the present invention (Part 1);

FIG. 9 is a schematic diagram showing an exemplary configuration of XML data in a case of transferring log information (not bound) to a server according to an embodiment of the present invention (Part 2);

FIG. 10 is a sequence diagram showing another operation (process) of a log management system according to an embodiment of the present invention;

FIG. 11 is a schematic diagram showing another example of a log management system according to an embodiment of the present invention;

FIG. 12 is a sequence diagram showing an operation (process) of a log management system according to an embodiment of the present invention;

FIG. 13 is a schematic diagram showing an exemplary configuration of bound log information according to an embodiment of the present invention;

FIG. 14 is a sequence diagram showing another operation (process) of a log management system according to an embodiment of the present invention;

FIG. 15 is a schematic diagram showing another example of a log management system according to an embodiment of the present invention;

FIG. 16 is a sequence diagram showing an operation (process) of a log management system according to an embodiment of the present invention;

FIG. 17 is a sequence diagram showing another operation (process) of a log management system according to an embodiment of the present invention;

FIG. 18 is a schematic diagram showing an example of a log management system according to an embodiment of the present invention;

FIG. 19 is a sequence diagram showing another operation (process) of a log management system according to an embodiment of the present invention;

FIG. 20 is a schematic diagram showing an exemplary configuration of bound log information according to an embodiment of the present invention;

FIG. 21 is a schematic diagram showing an exemplary configuration of XML data in a case of transferring bound log information to a server according to an embodiment of the present invention (Part 1);

FIG. 22 is a schematic diagram showing an exemplary configuration of XML data in a case of transferring bound log information to a server according to an embodiment of the present invention (Part 2);

FIG. 23 is a schematic diagram showing an example of a log management system according to an embodiment of the present invention;

FIG. 24 is a schematic diagram showing a process of binding log information of a successfully (normally) ended job and log information of an abnormally ended job according to an embodiment of the present invention; and

FIG. 25 is a schematic diagram showing an exemplary process of referring to log information according to an embodiment of the present invention.

### DESCRIPTION OF THE PREFERRED EMBODIMENTS

In the following, embodiments of the present invention will be described with reference to the accompanying drawings.

Although an example of a multifunction printer (hereinafter referred to as “MFP”) is described in the below-given embodiment of the present invention, other image processing apparatuses that perform an image forming process may also be employed.

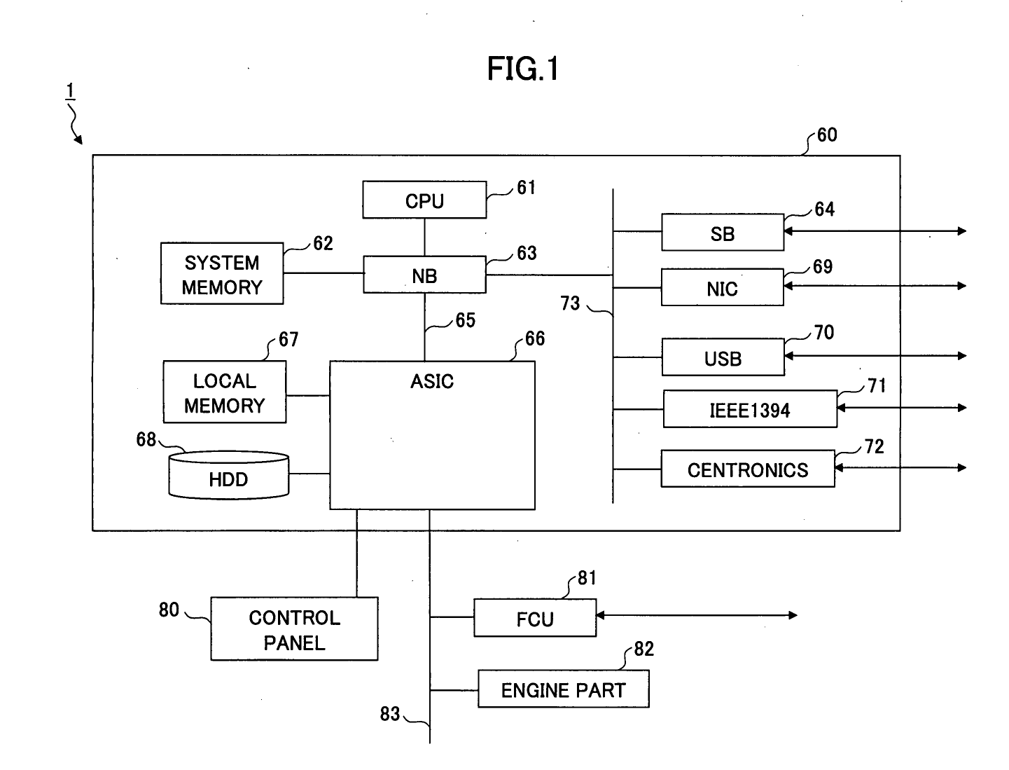

FIG. 1 is a schematic drawing showing an exemplary hardware configuration of a MFP 1. The MFP 1 shown in FIG. 1 includes, for example, a controller 60, a control panel 80, a FCU 81, and an engine part 82. The controller 60 includes, for example, a CPU 61, a system memory 62, a NB (North Bridge) 63, a SB (South Bridge)-64, a ASIC 66, a local memory 67, a HDD 68, a NIC (Network Interface Card) 69, a UDB I/F 70, a IEEE 1394 I/F 71, and a centronics I/F 72.

The control panel 80 is connected to the ASIC 66 of the controller 60. Furthermore, the FCU 81 and the engine part 82 are connected to the ASIC 66 of the controller 60 via the PCI bus 83.

In the controller 60, the ASIC 66 is connected to, for example, the local memory 67 and the HDD 68. In addition, the ASIC 66 is connected to the CPU via the NB 63 of a CPU chip set. Furthermore, the ASIC 66 and the NB 63 are connected via an AGP (Acclerated Graphics Port) 65.

The CPU 61 performs overall control of the MFP 1. In the MFP 1, the CPU 61 activates one or more service modules (described below) as a process in an operating system (OS) such as UNIX (registered trademark). The service module interprets a request(s) from an application(s) and operates a hardware resource(s).

The NB (North Bridge) 63 is a bridge for connecting the CPU 61, the system memory 62, the SB 64, the ASIC 66, the NIC 69, the USB I/F 70, the IEEE 1394 I/F 71, and the centronics I/F 72. The NB 63 is connected the SB 64, the NIC 69, the USB I/F 70, the IEEE 1394 I/F 71 and the centronics I/F 72 via the PCI bus 73. The SB (South Bridge) is a bridge for connecting, for example, the PCI bus 73, ROM (not shown) and other peripheral devices (not shown).

The system memory 62 is a memory used, for example, as a memory for a pictorial purpose. The local memory 67 is a memory used, for example, as an image buffer for a copying purpose, and a code buffer. The ASIC 66 is an IC having a hardware element for image processing and being suited for an image processing purpose. Furthermore, the HDD 68 is an example of a storage (auxiliary memory apparatus) for storing, for example, image data, text data, programs, font data, forms, and log information.

The NIC (Network Interface Card) 69 is an interface device for connecting to the MFP 1 to a network such as the Internet, and/or a LAN. Furthermore, the USB I/F 70, the IEEE 1394 I/F 71, and the centronics I/F 72 each are interfaces complying to predetermined standards.

The control panel 80 is a control part for receiving input from the controls of the operator and displaying information to the operator. The FCU (Fax Control Unit) 81 is for managing a facsimile unit. The engine part 82 is a collection of software and hardware that provide the functions of, for example, a printer, a copy machine, a facsimile machine, a scanner. For example, the portion corresponding to a printer mechanism is referred to as a printer engine. Next, a log management system including the MFP 1 according to an embodiment of the present invention is described.

### First Embodiment

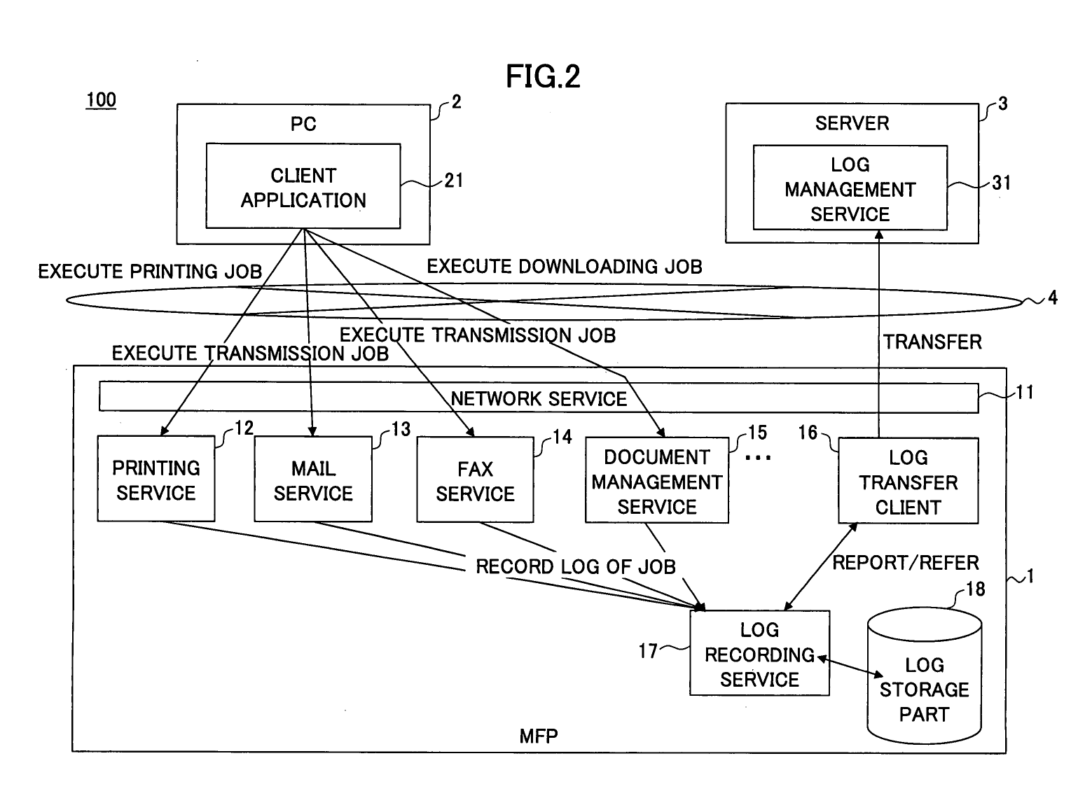

FIG. 2 is a schematic diagram showing an exemplary configuration of a log management system 100 according to an embodiment of the present invention. In the log management system 100 shown in FIG. 2, the MFP 1, a personal computer (hereinafter referred to as “PC”) 2, and a server 3 are connected via a network 4 (e.g. Internet, LAN). The PC 2 is an example of a terminal operated by an operator (user). The server 3 is an example of a log management apparatus for managing log information.

The MFP 1 shown in FIG. 2 serves to activate service modules including, for example, a network service 11, a printing service 12, a mail service 13, a fax service 14, a document management service 15, a log transfer client 16, and a log recording service 17. Furthermore, the MFP 1 has a log storage part 18 that is provided in, for example, the HDD 68 for recording log information.

The PC 2 activates a client application 21 that receives input controls by the operator and displays information to the operator. Furthermore, the client application 21 receives a request requesting execution of an image forming process from the operator. The client application 21 interprets the request for the image forming process received from the operator and identifies a series of jobs for performing the image forming process. A service module of the MFP 1, serving to execute one or more of the identified jobs, receives a job execution request requested by the client application 21.

The service module of the MFP 1 executes the job(s) when the service module of the MFP 1 receives the job execution request from the client application 21. The log recording service 17 receives log information from the service module and records the log information in the log storage part 18. The log information, which is recorded in the log storage part 18, is associated with the series of jobs for performing the image forming process (image forming operation) requested by the operator (described in detail below).

When the log information is recorded in the log storage part 18, the log recording service 17 reports the recording of the log information to the log transfer client 16. The log transfer client 16 refers to the recorded log information in correspondence with each report or each predetermined interval of time and transfers the log information to the server 3. The server 3 activates the log management service 31 and manages the log information transferred from the log transfer client 16 of the MFP 1.

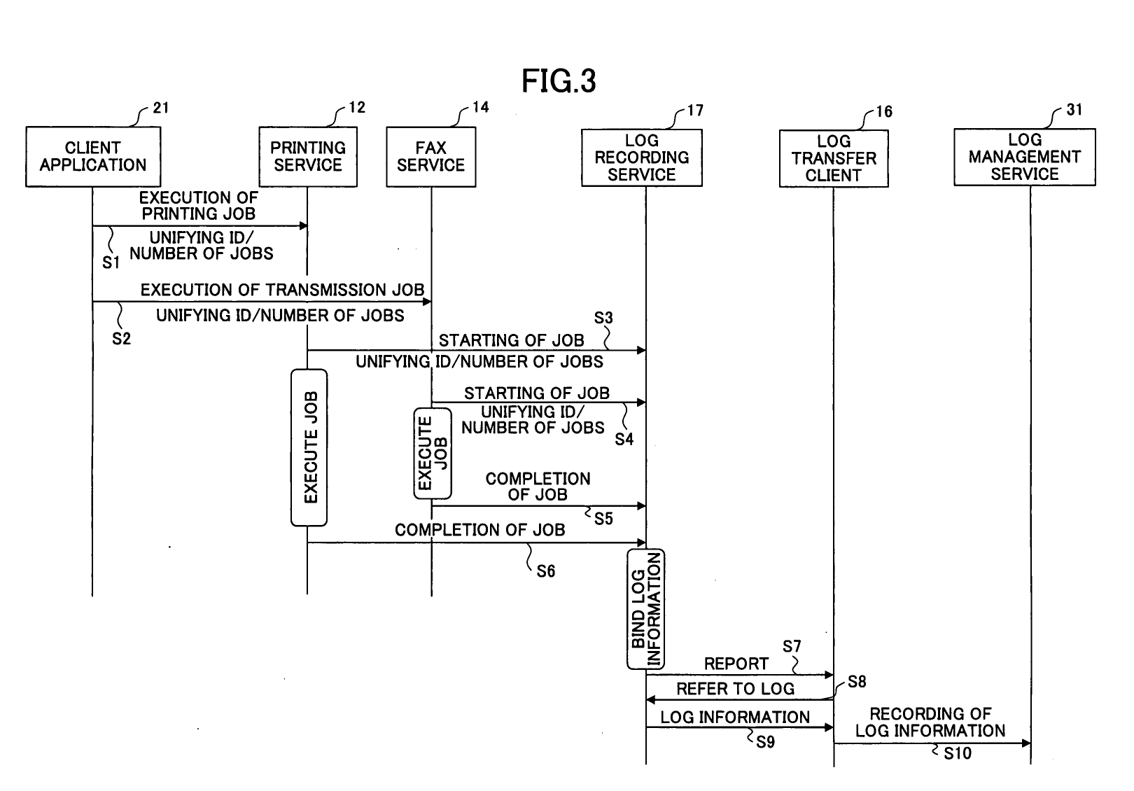

Next, the processes of the log management system shown in FIG. 2 are described. FIG. 3 is a sequence diagram showing an example of the processes of a log management system according to one embodiment of the present invention. In Step S1, the client application 21 of the PC 2 transmits a printing job execution request (which includes information containing unifying ID (integrating ID) and job count) to the printing service 12 of the MFP 1. In this example, the unifying ID is an identifier that associates a series of jobs originating from a single operation requested by the operator. Furthermore, the job count is the number of jobs included in the series of jobs originating from a single operation of the operator. In Step S2, the client application 21 of the PC 2 transmits a transmission job execution request (which includes information containing unifying ID and job count) to the fax service 14 of the MFP 1.

In Step S3, when the printing service 12 receives the printing job execution request from the client application 21, the printing service 12 transmits a printing job start report (which includes information containing unifying ID and job count) to the log recording service 17 and then starts execution of a printing job. In Step S4, when the fax service 14 receives the transmission job execution request from the client application 21, the fax service 14 transmits a transmission job start report (which includes information containing unifying ID and job count) to the log recording service 17 and then starts execution of a transmission job.

In Step S5, the fax service 14 transfers a transmission job completion report to the log recording service 17 after the transmission job is completed. Furthermore, in Step S6, the printing service 12 transfers a printing job completion report to the log recording service 17 after the printing job is completed.

Since the log recording service 17 receives the information containing unifying ID and job count in Steps S3 and S4, the log recording service 17 can determine that the series of jobs originating from the single operation requested by the operator is the printing job executed by the printing service 12 and the transmission job executed by the fax service 14. Accordingly, the log recording service 17 is able to determine that the series of jobs originating from the single operation requested by the operator is completed when receiving the transmission job completion report and the printing job completion report of Steps S5 and S6, respectively.

After the log recording service 17 determines that the series of jobs originating from the single operation requested by the operator is completed, the log recording service 17 gathers the log information corresponding to the printing job executed by the printing service 12 and the log information corresponding to the transmission job executed by the fax service 14 and combines the log information corresponding to the printing job and the log information corresponding to the transmission job into a single log information item. The process of gathering plural log information items and combining the plural log information items into a single log information item is hereinafter referred to as “binding”.

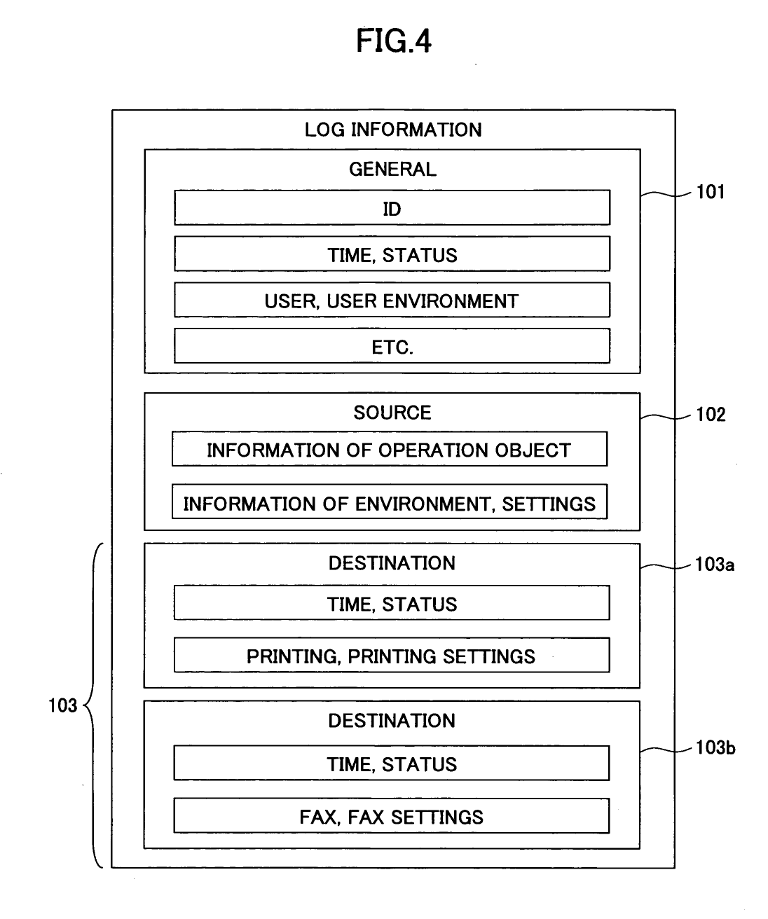

FIG. 4 is a schematic diagram showing an exemplary configuration of log information subjected to the binding process (i.e. bound log information). FIG. 4 shows bound log information in a case where the same stored document is subjected to the printing job and the transmission (fax transmission) job. The bound log information includes General information 101, Source information 102, and Destination information 103.

The General information 101 includes overall information of a series of jobs originating from a single operation requested by the operator. The Source information 102 includes information of the object that is to be operated (handled) by a service module. For example, the Source information 102 of FIG. 4 includes information of the same stored document which is to be printed and transmitted (transmitted by fax).

The Destination information 103 includes information of the object that is operated (handled) by a service module. For example, the bound log information of FIG. 4 includes Destination information 103a containing information of the printed same stored document and Destination information 103b containing information of the transmitted same stored document. It is to be noted that the value (number) of the Source information 102 and the Destination information 103 included in the bound information changes according to the series of jobs originating from the operation by the operator.

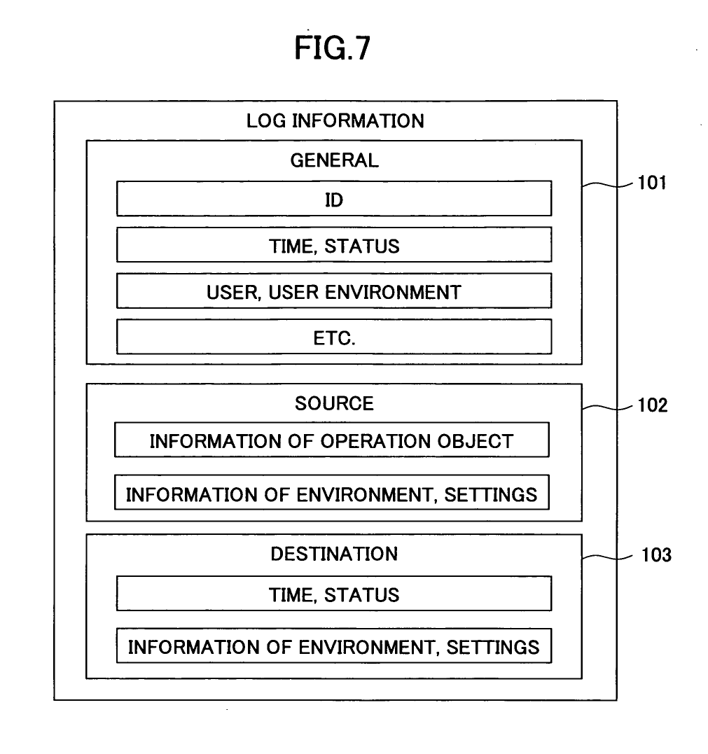

After the log information of the printing job executed by the printing service 12 and the log information of the transmission job executed by the fax service 14 are bound by the log recording service 17, the log recording service 17 records the bound information in the log storage part 18. Next, in Step S7 of FIG. 7, the log recording service 17 reports that the bound information has been recorded in the log storage part to the log transfer client 16.

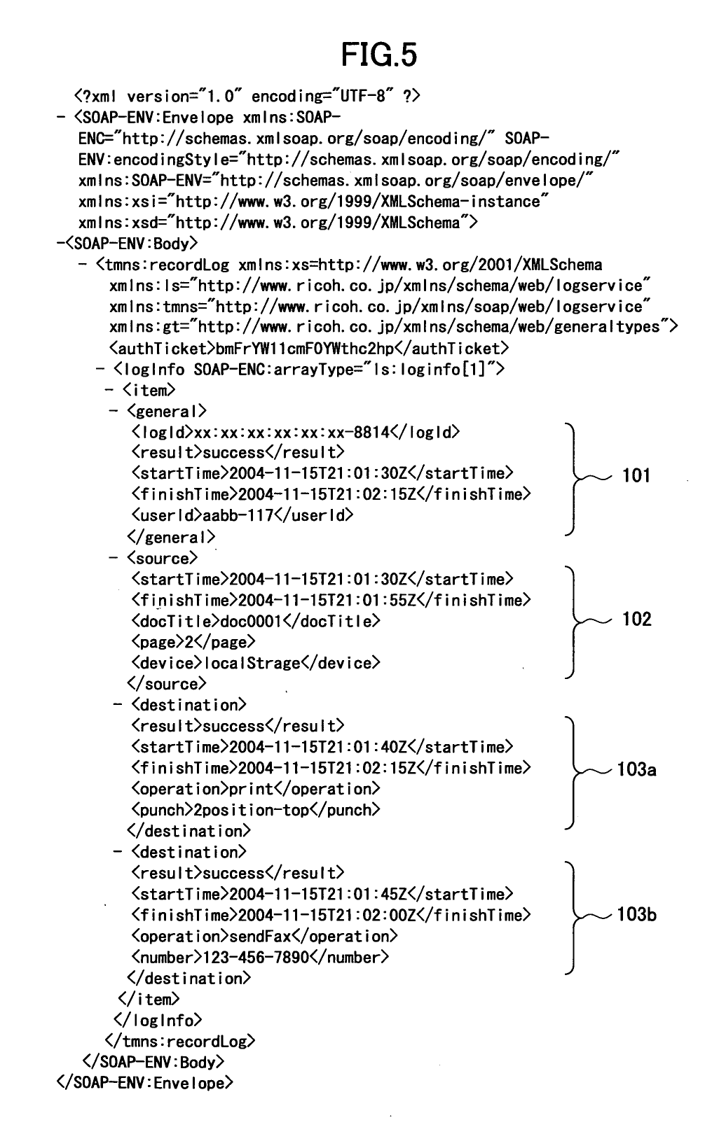

Next, in Step S8, the log transfer client 16 refers to the log information recorded in the log storage part 18 in correspondence with each report or each predetermined interval of time. Next, in Step S9, the log transfer client 16 receives log information from the log storage part 18 via the log recording service 17. Next, in Step S10, the log transfer client 16 transfers the log information transmitted from the log recording service 17 to the log management service 31 of the server 3 in the form of, for example XML data shown in FIG. 5.

FIG. 5 shows an exemplary configuration of XML data in the case where the bound log information in the XML data is transferred to the server 3. The configuration of the XML data shown in FIG. 5 includes General information 101, Source information 102, and Destination information 103a, 103b.

Furthermore, the log management service 31 extracts the log information from the XML data transferred from the log transfer client 16 of the MFP 1 and records the extracted log information in, for example, a HDD, to thereby manage the log information.

Hence, according to the sequence diagram of FIG. 3, the binding process enables the bound log information including plural log information items of a series of jobs to be associated with a corresponding single operation of the operator. Therefore, in the sequence diagram of FIG. 3, since plural log information items of a series of jobs corresponding to a single operation requested by the operator can be bound into a single log information item, traffic can be reduced and resources can be saved when transferring the log information. It is also convenient for the operator since the operator can distinguish log information originating from a single operation.

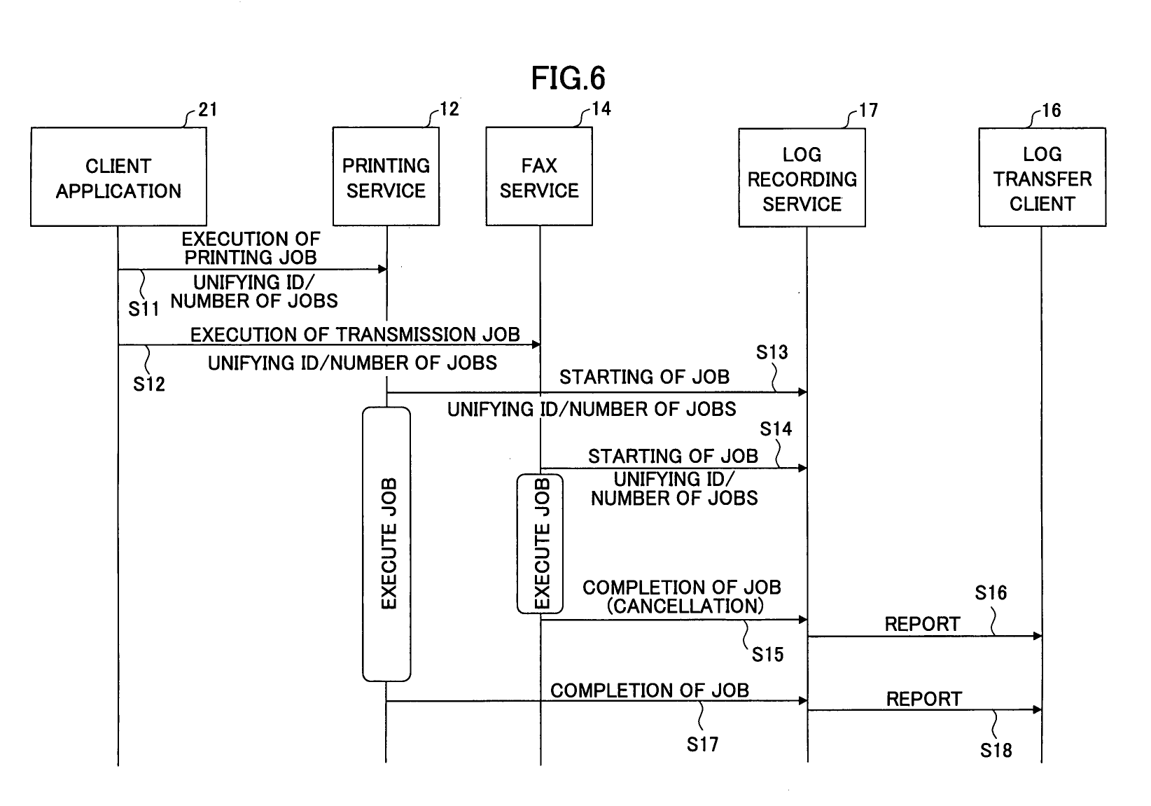

FIG. 6 is a sequence diagram showing an example of the processes of a log management system according to another embodiment of the present invention. Except for a portion of FIG. 6, like parts are denoted by like numerals as of FIG. 3 and are not further explained.

Steps S11 to S14 of FIG. 6 are the same as Steps S1 to S4 of FIG. 3. Then, in Step S15 of FIG. 6, the fax service 14 transmits a transmission job end (cancellation) report indicating abnormal end of the transmission job when an abnormal end of the transmission job occurs.

When the transmission job end report indicating an abnormal end of the transmission job from the transmission service 14 is received by the log recording service, the log recording service 17 records log information of the transmission job executed by the fax service 14 without waiting for the completion of all the jobs originating from a single operation requested by the operator. That is, the log recording service 17 does not bind the plural log information items of the series of jobs originating from the single operation requested by the operator.

In Step S16, after the log recording service 17 records the log information of the transmission job executed by the fax service 14 in the log storage part 18, the log recording service 17 reports the recording of the log information to the log transfer client 16. Next, in Step S17, the printing service 12 transmits a printing job completion report to the log recording service when the printing service 12 completes the printing job. When the printing job completion report (indicative of the completion of the printing job) from the printing service 12 is received by the log recording service 17, the log recording service 17 records the log information of the printing job executed by the printing service 12 in the log storage part 18.

In Step S18, after the log information of the printing job executed by the printing service 12 is recorded in the log storage part 18, the log recording service 17 reports the recording of the log information in the log storage part 18 to the log transfer client 16.

FIG. 7 shows an exemplary configuration of log information that is not bound. The log information shown in FIG. 7 includes General information 101, Source information 102, and Destination information 103.

The General information 101 includes information includes overall information of a series of jobs originating from a single operation requested by the operator. The Source information 102 includes information of the object that is to be operated (handled) by a service module. The Destination information 103 includes information of the object that is operated (handled) by a service module.

The log recording service 17 separately records the log information of the printing job executed by the printing service 12 and the log information of the transmission job executed by the fax service 14 in the log storage part 18, in which each of the separately recorded log information items has the configuration shown in FIG. 7.

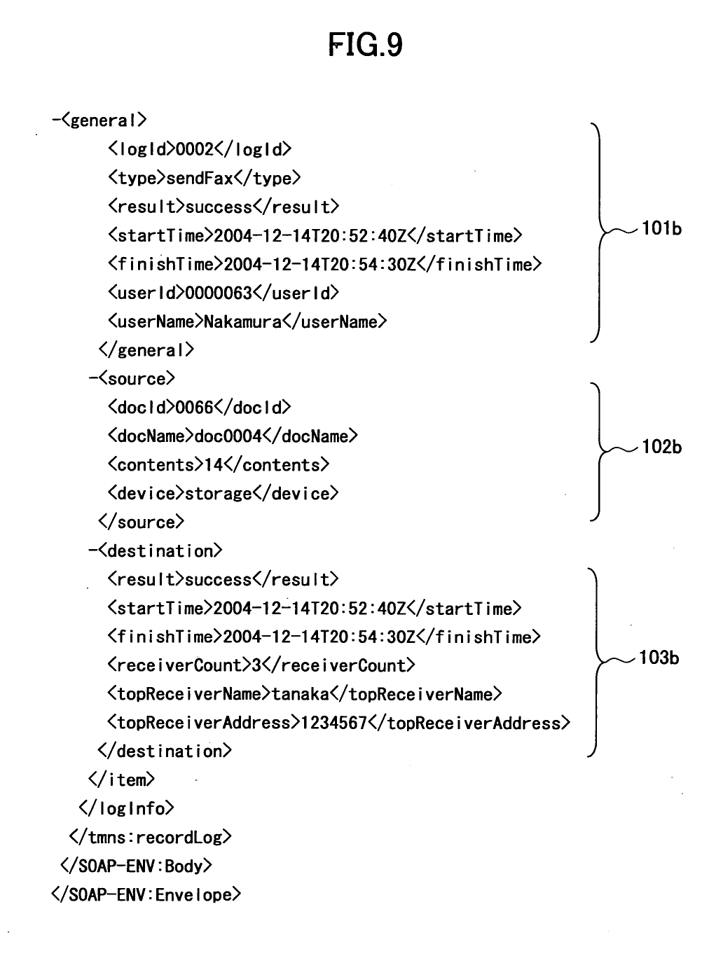

The same as Steps S8 to S10 of FIG. 3, the log transfer client 16 refers to the recorded log information in correspondence with each report or each predetermined interval of time and receives log information from the log storage part 18 via the log recording service 17. Then, the log transfer client 16 transfers the log information received from the log recording service 17 to the log management service 31 of the server 3 in the form of XML data shown in FIG. 9.

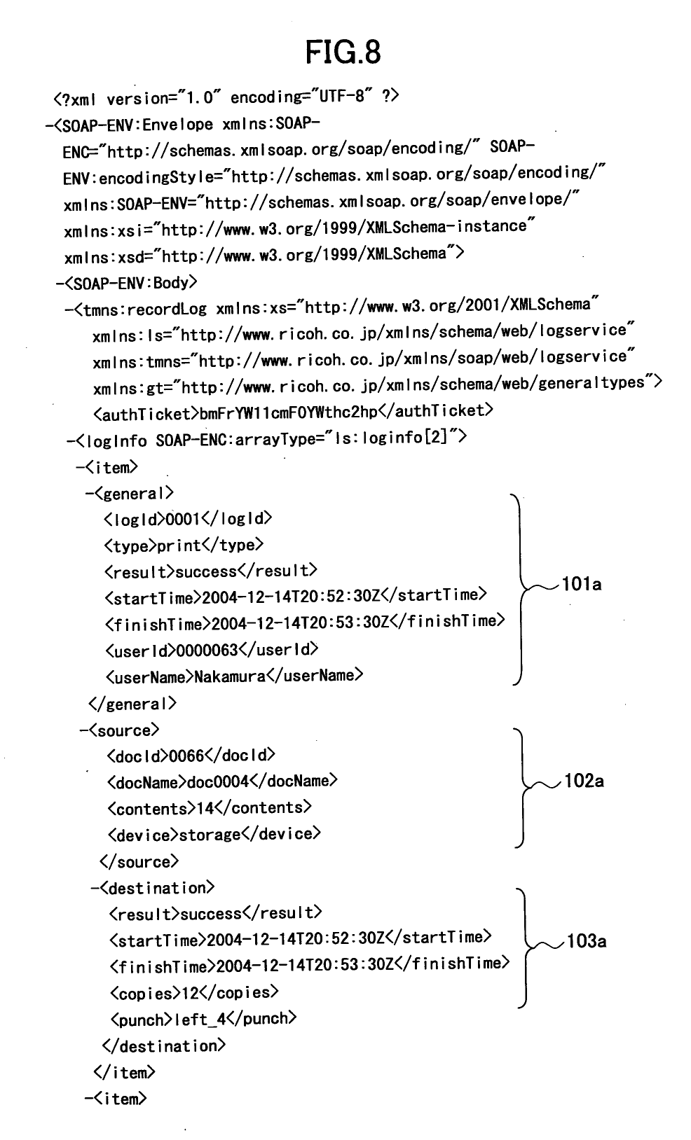

FIGS. 8 and 9 show exemplary configurations of XML data in a case of transferring log information (not bound) to the server 3. In a manner similar to the bound data of FIG. 7, the XML data shown in FIGS. 8 and 9 are provided with General information 101a, Source information 102a, and Destination information 103a indicative of log information of the printing job executed by the printing service 12; and General information 101b, Source information 102b, and Destination information 103b indicative of log information of the transmission job executed by the fax service 14.

The log management service 31 extracts log information from the XML data (shown in FIGS. 8 and 9) transferred from the log transfer client 16 of the MFP 1 and records the extracted log information in, for example, a HDD, to thereby manage the log information.

Hence, although plural log information items are not bound together in the example shown in the sequence diagram of FIG. 6, the plural log information items of a series of jobs originating from a single operation requested by the operator are associated (related) with each other by using the unifying ID (integrating ID) in the General information 101 of the log information as an ID. Accordingly, the plural log information items of a series of jobs originating from a single operation of the operator can be associated with each other by performing the processes shown in the sequence diagram of FIG. 6. It is convenient for the operator since the log information: originating from the single operation can be identified.

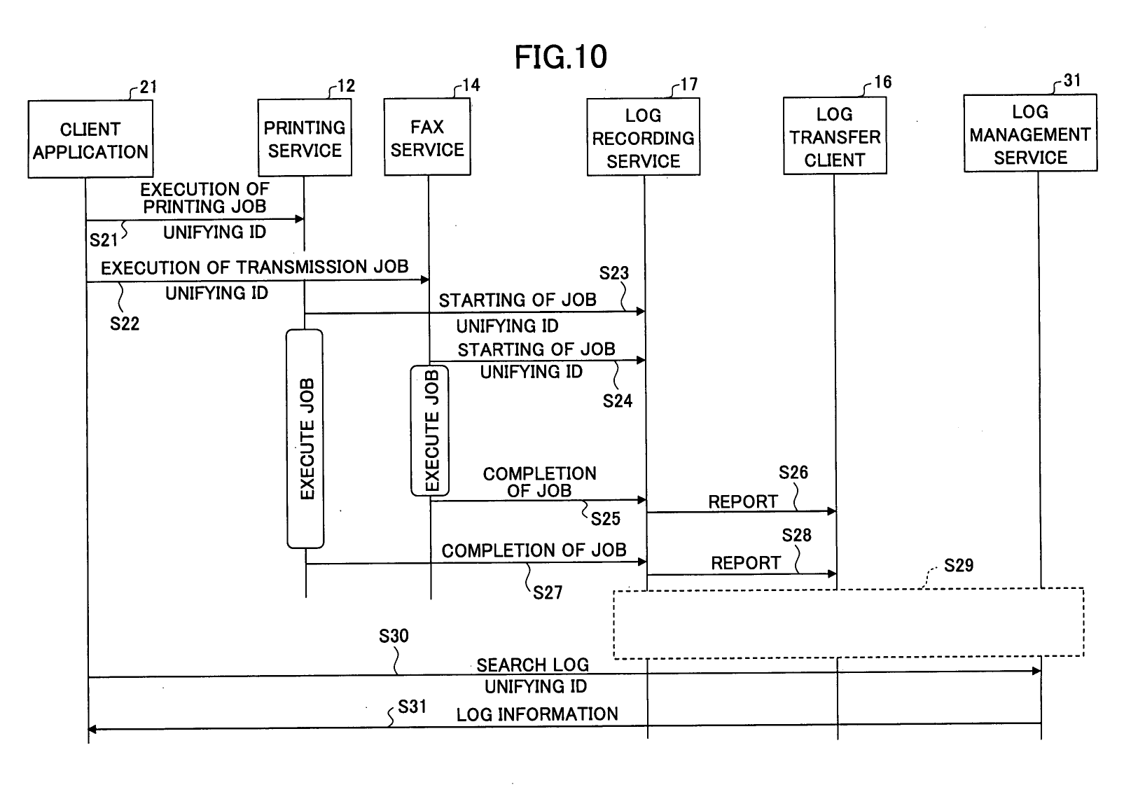

FIG. 10 is a sequence diagram showing an example of the processes of a log management system according to another embodiment of the present invention. Except for a portion of FIG. 10, like parts are denoted by like numerals as of FIGS. 3, 6 and are not further explained.

In Step S21, the client application 21 of the PC 2 transmits a printing job execution request including unifying ID information to the printing service 12 of the MFP 1. In Step S22, the client application 21 of the PC 2 transmits a transmission job execution request including unifying ID information to the fax service 14 of the MFP 1.

In Step S23, when the printing job execution request is received by the printing service 12, the printing service 12 transmits a printing job start report including information of unifying ID to the log recording service 17 and then executes the printing job. In Step S24, when the transmission job execution request is received by the fax service 14, the fax service 14 transmits a transmission job start report including information of unifying ID to the log recording service 17 and then executes the transmission job.

In Step S25, when the transmission job is completed by the fax service 14, the fax service 14 transmits a transmission job completion report to the log recording service 17. When the transmission job completion report is received by the log recording service 17, the log recording service 17 records the log information of the transmission job executed by the fax service 14 in the log storage part 18.

In Step S26, after the log information of the transmission job executed by the fax service 14 is stored in the log storage part 18, the log recording service 17 reports that the log information of the transmission job executed by the fax service 14 is recorded in the log storage part 18 to the log transfer client 16.

In Step S27, after the printing job is completed, the printing service 12 transmits a printing job completion report to the log recording service 17. When the printing job completion report (indicating completion of the printing job) is received by the log recording service 17, the log recording service 17 records log information of the printing job executed by the printing service 12 in the log storage part 18.

In Step S28, after the log recording service 17 records the log information of the printing job executed by the printing service 12 in the log storage part 18, the log recording service 17 reports that the log information of the printing job executed by the printing service 12 is recorded in the log storage part 18 to the log transfer client 16.

Since the log recording service 17 does not receive information regarding the number of jobs in Steps 23 and 24, the log recording service 17 is unable to determine the number of jobs originating from a single operation requested by the operator. Therefore, the log recording service 17 stores log information items of a series of jobs originating from a single operation requested by the operator in the log storage part 18 without binding them. The log recording service 17 separately records the log information of the printing job executed by the printing service 12 and log information of the transmission job executed by the transmission service 14 in the log storage part 18k, in which each of the log information items has a configuration shown in FIG. 7.

Same as Steps S8 to S10 of FIG. 3, the log transfer client 16 refers to the recorded log information in correspondence with each report or each predetermined interval of time and receives log information from the log storage part 18 via the log recording service 17. Then, the log transfer client 16 transfers the log information received from the log recording service 17 to the log management service 31 of the server 3 in the form of XML data shown in FIG. 9 or FIG. 8. The log management service 31 extracts the log information from the XML data (as shown in FIG. 8 or FIG. 9) transferred from the log transfer client 16 of the MFP 1 and records the extracted log information in, for example, a HDD, to thereby manage the log information.

In Step S30, the client application 21 of the PC 2 transmits a log search request including the unifying ID to the log management service 31 of the server 3. The log management service 31 uses the unifying ID as the key information for searching for log information. Accordingly, all of the jobs originating from a single operation requested by the operator can be determined. In Step S31, the log management service 31 transmits the log information of the series of jobs originating from the single operation of the operator to the client application 21 of the PC 2.

Hence, although plural log information items are not bound together in the example shown in the sequence diagram of FIG. 10, the plural log information items of a series of jobs originating from a single operation of the operator are associated with each other by using the unifying ID in the General information 101 of the log information as an ID. Accordingly, the plural log information items of a series of jobs originating from a single operation of the operator can be searched by performing the processes shown in the sequence diagram of FIG. 10. It is convenient for the operator since the log information originating from the single operation can be identified.

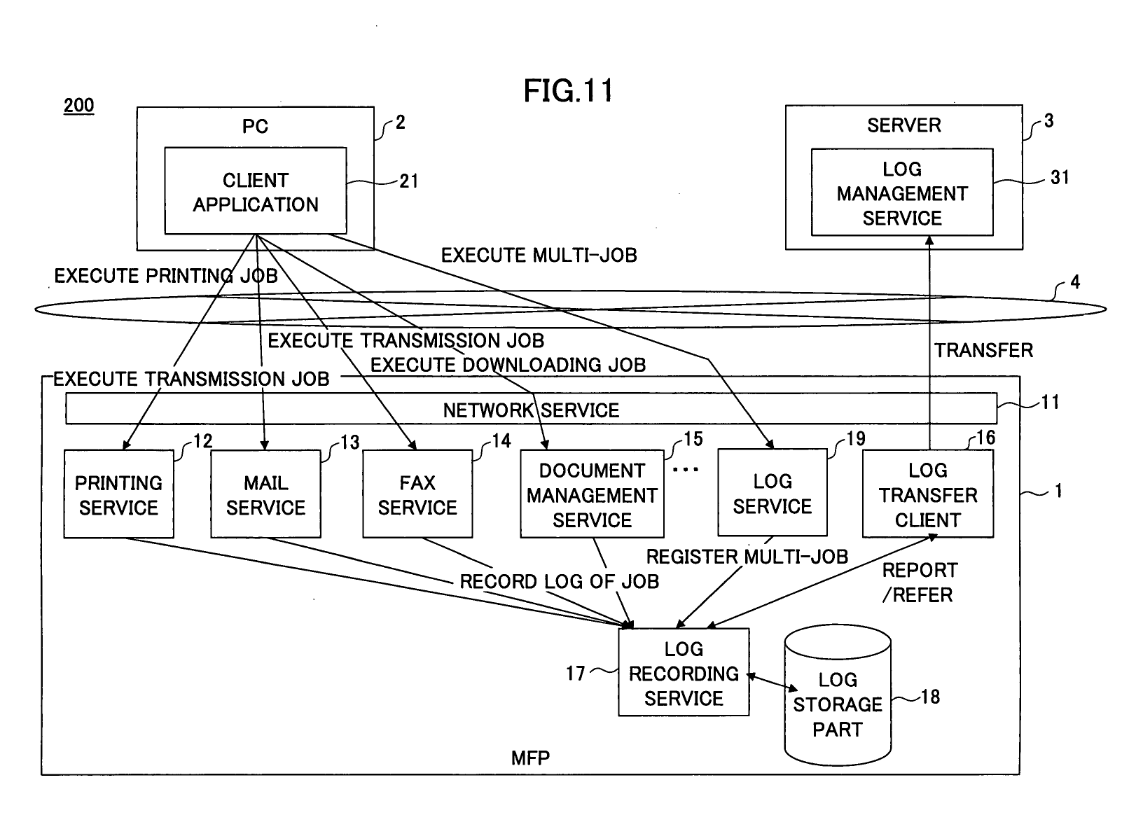

FIG. 11 is a schematic drawing showing an exemplary configuration of a log management system 200 according to another embodiment of the present invention. Except for a portion of FIG. 11, like parts are denoted by like numerals as of FIG. 2 and are not further explained. The log management system 200 shown in FIG. 11 is different from the log management system 100 shown in FIG. 2 mainly in that the log management system 200 includes a log service 19 which serves as a service module of the MFP 1.

The log service 19 receives a multi-job execution request (described below) from the client application 21 and transmits a multi-lob registration request to the log recording service for associating (relating) plural log information items of a series of jobs.

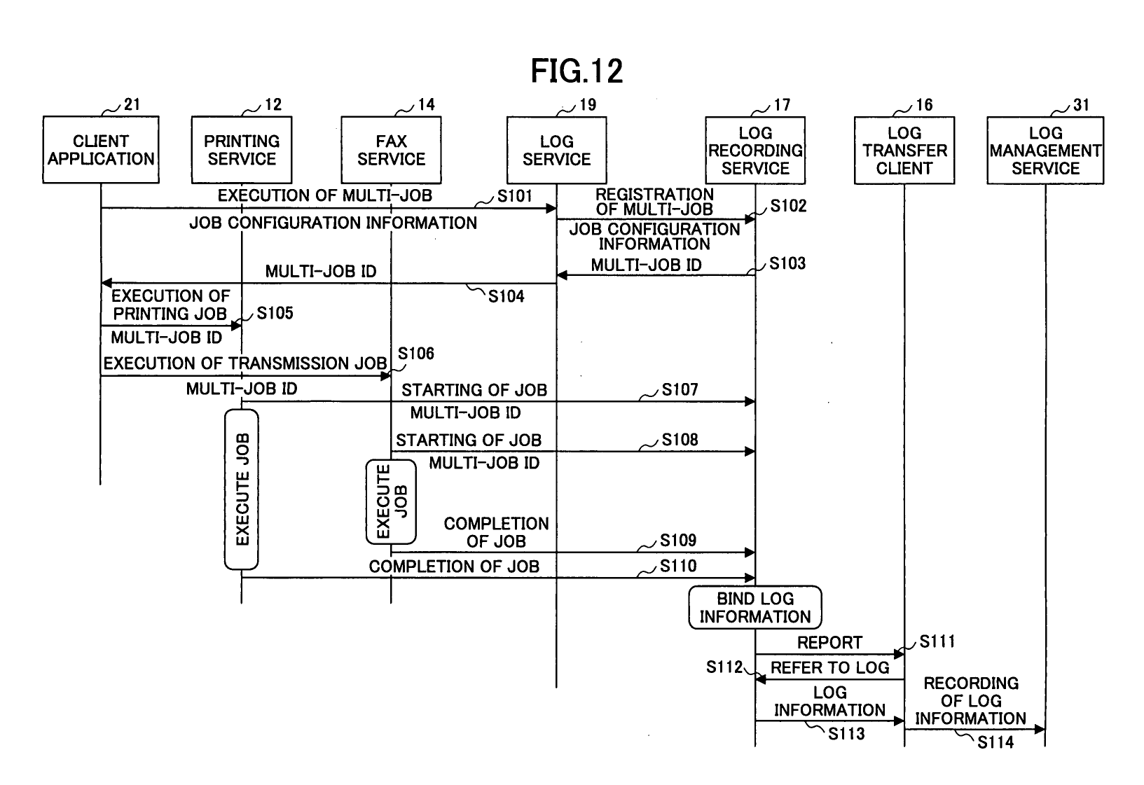

Next, the processes of the log management system 200 shown in FIG. 11 are described. FIG. 12 is a sequence diagram showing an example of the processes of a log management system according to another embodiment of the present invention. Except for a portion of FIG. 10, like parts are denoted by like numerals as of FIGS. 3, 6 and are not further explained.

In Step S101 of FIG. 12, the client application 21 of the PC 2 transmits a multi-job execution request including job configuration information to the log service of the MFP 1. In this example, “job configuration information” refers to information indicating the configurations of the series of jobs originating from a single operation requested by the operator.

In Step S102, the log service 19 transmits a multi-job registration request including the job configuration information to the log recording service 17. When the multi-job registration request from the log service is received by the log recording service 17, the log recording service 17 issues a multi-job ID as an identifier for associating (relating) the series of jobs originating from the single operation requested by the operator.

In Step S103, the log recording service 17 transmits the multi-job ID to the log service 19. In Step S104, the log service 19 transmits the multi-job ID to the client application 21 of the PC 2.

In Step S105, the client application 21 transmits a printing job execution request including information of the multi-job ID to the printing service 12 of the MFP 1. In Step S106, the client application 21 transmits a transmission job execution request including information of the multi-job ID to the fax service 14 of the MFP 1.

In Step S107, when the printing service 12 receives the printing job execution request from the client application 21, the printing service 12 transmits a printing job start report including the information of the multi-job ID to the log recording service 17 and then starts execution of a printing job. In Step S108, when the fax service 14 receives the transmission job execution request from the client application 21, the fax service 14 transmits a transmission job start report including the information of the multi-job ID to the log recording service 17 and then starts execution of a transmission job.

In Step S109, when the fax service 14 completes the transmission job, the fax service 14 transmits a transmission job completion report to the log recording service 17. In Step S110, when the printing service 12 completes the printing job, the printing service 12 transmits a printing job completion report to the log recording service 17.

Since the log recording service 17 receives the job configuration information in Step S101 and receives information of the multi-job ID in Steps S107 and S108, the log recording service 17 can determine that the series of jobs originating from the single operation of the operator correspond to the printing job executed by the printing service 12 and the transmission job executed by the fax service 14. Accordingly, when the log recording service 17 receives the transmission job completion report in Step S109 and the printing job completion report in Step S10, the log recording service 17 can determine that all of the series of jobs originating from the single operation requested by the operator are completed.

When the log recording service 17 determines that all of the series of jobs originating from the single operation requested by the operator are completed, the log recording service 17 binds the log information of the printing job executed by the printing service 12 and the log information of the transmission job executed by the fax service 14 together.

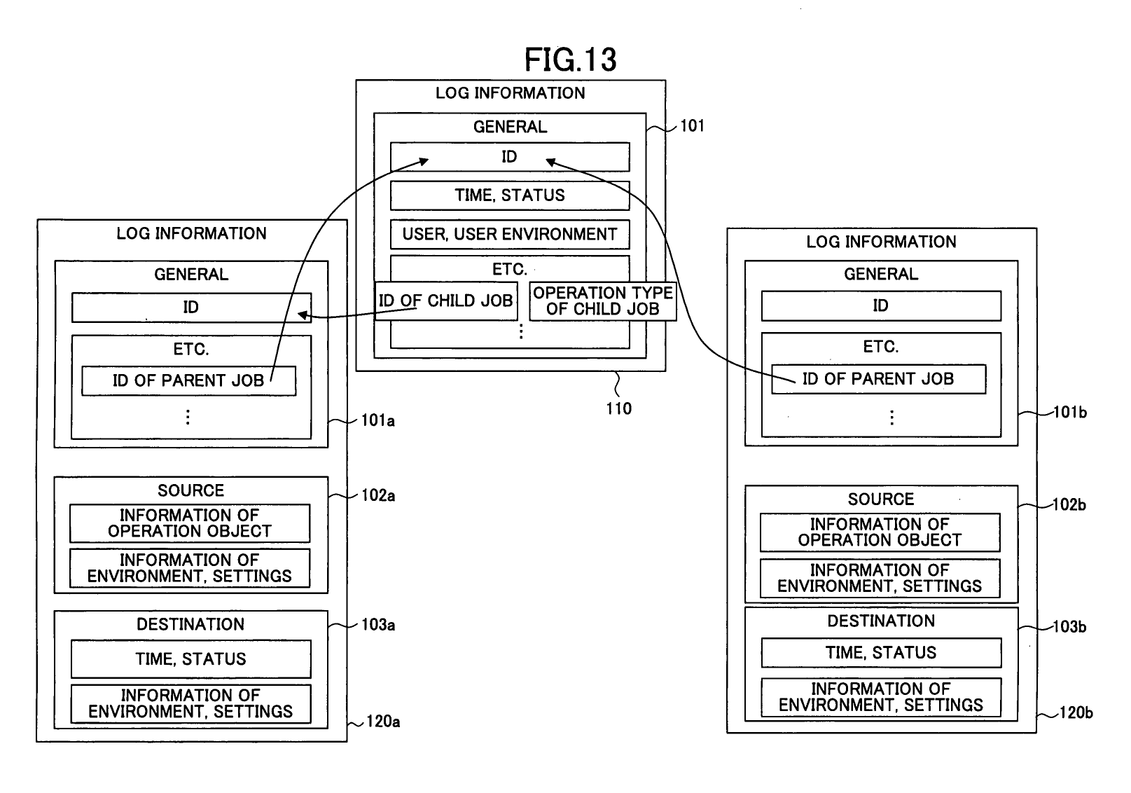

FIG. 13 is a schematic drawing showing an exemplary configuration of plural log information items that are bound together. The log information of FIG. 13 includes common log information (i.e. log information that is commonly shared among the series of jobs) 110, and respective log information (i.e. log information corresponding to each job) 120a, 120b.

The common log information 110 includes General information 101. The respective information 120a includes General information 101a, Source information 102a, and Destination information 103a. The respective information 120a includes General information 101b, Source information 102b, and Destination information 103b.

The common log information 110 includes, for example, information that is commonly shared among the series of jobs originating from a single operation requested by the operator. The respective log information items 120a, 120b include, for example, log information of each printing job executed by the printing service 12 and each transmission job executed by the fax service 14, respectively.

The General information 101 of the common log information includes, for example, overall information of a series of jobs originating from a single operation requested by the operator. The General information items 101a, 101b of the respective log information 120a, 120b items include, for example, overall information of a single job. The Source information items 102a, 102b of the respective log information items 120a, 120b include, for example, information of the object that is to be operated (handled) by the service module. The Destination information items 103a, 103b of the respective log information items 120a, 120b include, for example, information of the object operated (handled) by the service module.

The common log information item 110 and the respective log information items 120a, 120b are associated (related) by having the ID included in the General information 101 of the common log information 110 associated with the ID included in the General information items 101a, 101b of the respective log information items 120a, 120b.

The log recording service 17 binds together the log information of the printing job executed by the printing service 12 and the log information of the transmission job executed by the transmission service 14 (as shown in FIG. 13) and records the bound log information in the log storage part 18. Since the processes of subsequent Steps S111 to S114 are the same as Steps S7 to S10 of FIG. 3, explanation of the processes of Steps S111 to S114 is omitted.

Hence, with the processes shown in the sequence diagram of FIG. 12, plural log information items of a series of jobs originating from a single operation requested by the operator can be associated by using the binding process. Accordingly, the plural information items of a series of jobs originating from a single operation of the operator can be associated by performing the processes shown in the sequence diagram of FIG. 12. It is convenient for the operator since log information originating from the single operation can be identified.

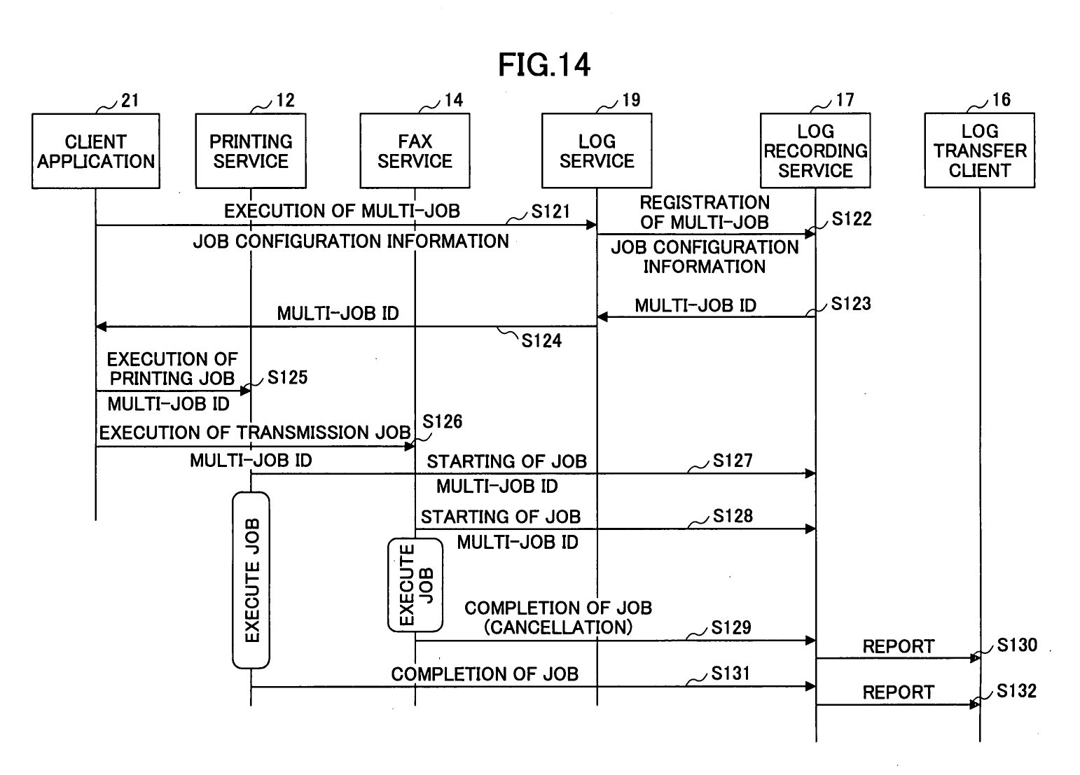

FIG. 14 is a sequence diagram showing an example of the processes of a log management system according to another embodiment of the present invention. Except for a portion of FIG. 14, like parts are denoted by like numerals as of FIGS. 3, 6, and 12 and are not further explained.

The processes of Steps S121 to S128 in FIG. 14 are the same as those of Steps S101 to S108 in FIG. 12. In Step S129, when the transmission job of the fax service 14 is ended due to an abnormality (abnormal end), the fax service 14 transmits a transmission job completion report indicating that the transmission job is ended due to abnormality to the log recording service 17.

When the log recording service 17 receives the transmission job completion report indicating end of the transmission job due to abnormality, the log recording service 17 records the log information of the transmission job executed by the fax service 17 in the log storage part 18 without waiting for the completion of the execution of all jobs in the series of jobs originating from the single operation requested by the operator. That is, the log recording service 17 does not bind the log information of the series of jobs originating from the single operation requested by the operator.

Then, in Step S130, after the log recording service 17 records the log information of the transmission job executed by the fax service 14 in the log storage part 18, the log recording service 17 reports that the log information of the transmission job executed by the fax service 17 is recorded in the log storage part 18 to the log transfer client 16.

In Step S131, after the printing service 12 completes the printing job, the printing service 12 transmits a printing job completion report to the log recording service 17. When the log recording service 17 receives the printing job completion report from the printing service 12, the log recording service 17 records the log information of the printing job executed by the printing service 12 in the log storage part 18.

In Step S132, after the log information of the printing job executed by the printing service 12 is recorded in the log storage part 18 by the log recording service 17, the log recording service 17 reports that the log information of the printing job executed by the printing service 12 is recorded to the log transfer client 16.

The log recording service separately records the log information of the printing job executed by the printing service 12 and the log information of the transmission job executed by the fax service 14 in the log storage part 18, in which each of the log information items is recorded having a configuration shown in FIG. 7.

Same as Steps S112 to S114 of FIG. 12, the log transfer client 16 refers to the recorded log information in correspondence with each report or each predetermined interval of time and receives log information from the log storage part 18 via the log recording service 17. Then, the log transfer client 16 transfers the log information received from the log recording service 17 to the log management service 31 of the server 3 in the form of XML data shown in FIG. 9.

The log management service 31 extracts log information from the XML data (as shown in FIGS. 8 and 9) transferred from the log transfer client 16 of the MFP 1 and records the extracted log information in, for example, a HDD, to thereby manage the log information.

Hence, although plural log information items are not bound together in the example shown in the sequence diagram of FIG. 14, the plural log information items of a series of jobs originating from a single operation of the operator are associated (related) by using the multi-job ID in the General information 101 of the log information as an ID. Accordingly, the plural log information items of a series of jobs originating from a single operation of the operator can be associated by performing the processes shown in the sequence diagram of FIG. 14. It is convenient for the operator since the log information originating from the single operation can be identified.

### Third Embodiment

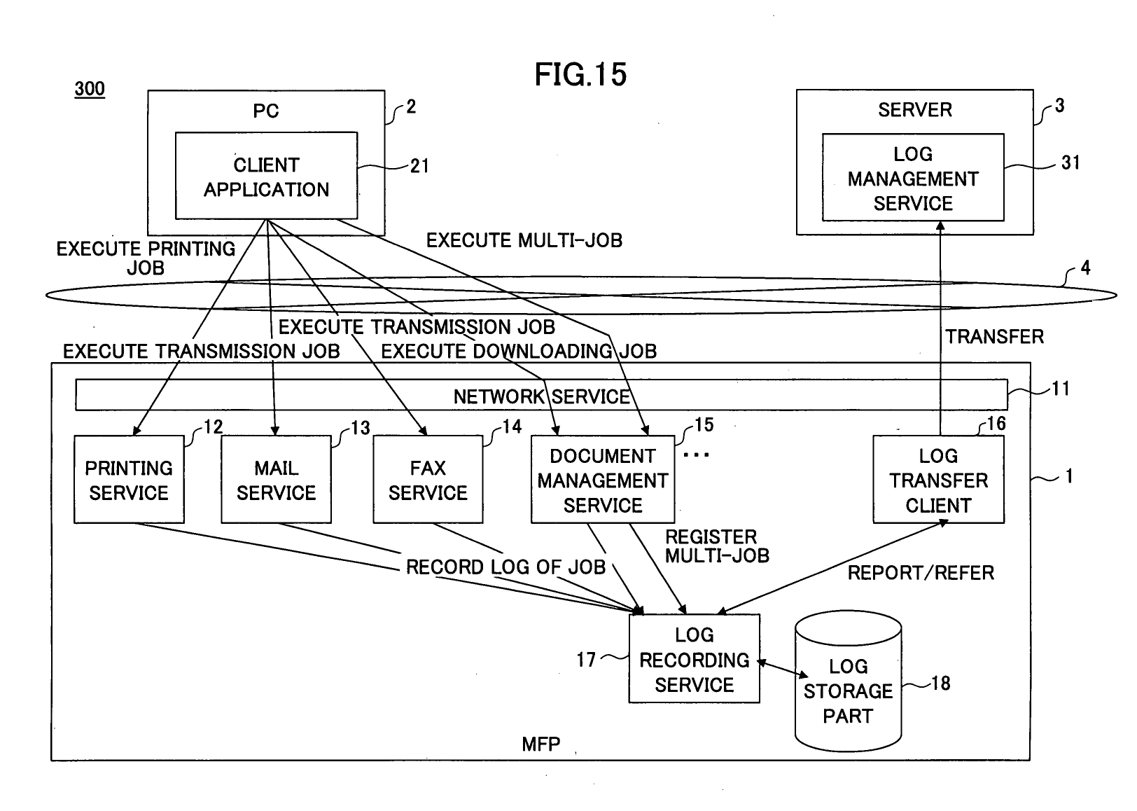

FIG. 15 is a schematic drawing showing an exemplary configuration of a log management system 300 according to another embodiment of the present invention. Except for a portion of FIG. 15, like parts are denoted by like numerals as of FIG. 2 and are not further explained. The log management system 300 shown in FIG. 15 is a system in which the document management service 15 of the MFP 1 receives a multi-job execution request (described below) from the client application 21 and transmits a multi-job registration request to the log recording service 17 for associating (relating) plural log information items of a series of jobs.

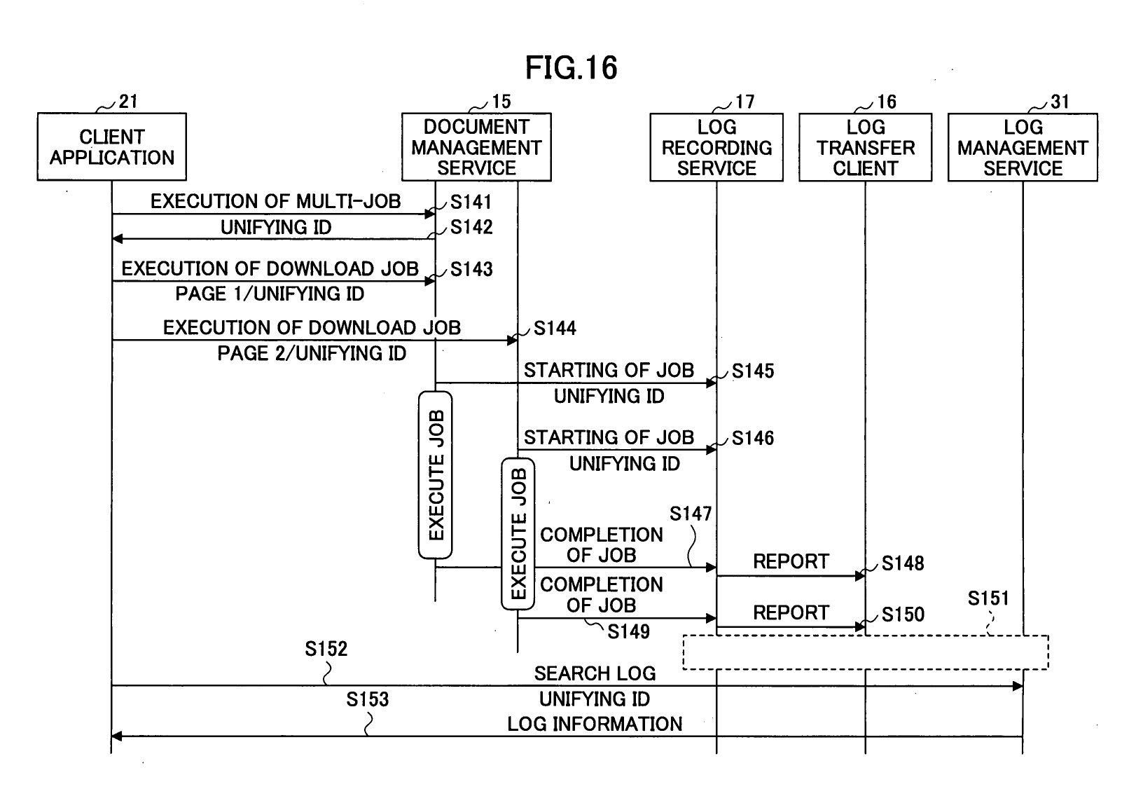

Next, the processes of the log management system 300 shown in FIG. 15 are described. FIG. 16 is a sequence diagram showing an example of the processes of a log management system according to another embodiment of the present invention. Except for a portion of FIG. 16, like parts are denoted by like numerals as of FIGS. 3, 6, and 10 and are not further explained.

In Step S141, the client application 21 of the PC 2 transmits a multi-job execution request to the document management service 15 of the MFP 1. When the multi-job execution request from the client application 21 is received by the document management service 15, the document management service 15 issues an unifying ID as an identifier for associating (relating) the series of jobs originating from the single operation requested by the operator.

In Step S142, the document management service 15 transmits the unifying ID to the client application 21 of the PC 2. In this example, the client application 21 downloads (hereinafter also referred to as “DL”) each page of the stored documents.

In Step S143, the client application 21 transmits a DL job execution request for a first page including information of the unifying ID to the document management service 15 of the MFP 1. In Step S144, the client application 21 transmits a DL job execution request for a second page including information of the unifying ID to the document management service 15 of the MFP 1. That is, the document management service 15 receives two DL job execution requests.

In Step S145, when the document management service 15 receives one of the DL job execution requests from the client application 21, the document management service 15 transmits a DL job start report including information of unifying ID to the log recording service 17 and then executes the DL job. In Step S146, when the document management service 15 receives the other one of the DL job execution requests from the client application 21, the document management service 15 transmits another DL job start report including information of another unifying ID to the log recording service 17 and then executes the other DL job.

In Step S147, when the document management service 15 completes one of the DL jobs, the document management service 15 transmits a DL job completion report to the log recording service 17. When the log recording service 17 receives the DL job completion report from the document management service 15, the log recording service 17 records the log information of the DL job executed by the document management service 15 in the log storage part 18.

In Step S148, after the log information of one of the DL jobs is recorded in the log storage part 18 by the log recording service 17, the log recording service 17 reports that the log information of the one of the DL jobs executed by the document management service 15 is recorded in the log storage part to the log transfer client 16.

In Step S149, when the document management service 15 completes another one of the DL jobs, the document management service 15 transmits a DL job completion report to the log recording service 17. When the log recording service 17 receives the DL job completion report from the document management service 15, the log recording service 17 records the log information of the DL job executed by the document management service 15 in the log storage part 18.

In Step S150, after the log information of the other one of the DL jobs is recorded in the log storage part 18 by the log recording service 17, the log recording service 17 reports that the log information of the other one of the DL jobs executed by the document management service 15 is recorded in the log storage part to the log transfer client 16.

Since the log recording service 17 receives no information of the number of jobs in Steps S145 or S146, the log recording service 17 is unable to determine the number of jobs originating from the single operation of the operator. Therefore, even if the log recording service 17 receives the DL completion reports in Steps S147 and S148, the log recording service 17 is unable to determine the completion of all jobs in the series of jobs originating from the single operation requested by the operator. Therefore, the log recording service 17 stores log information of the series of jobs originating from a single operation requested by the operator in the log storage part 18 without binding them.

The log recording service 17 separately records the log information of the two DL jobs executed by the document management service 15 in the log storage part 18, in which each of the log information items has a configuration as shown in FIG. 7. Since the processes of Steps S151 to S153 are the same as those of Steps S29 to S31 of FIG. 10, explanation of the processes of Steps S151 to S153 is omitted.

The log management service 31 can determine (identify) all of the series of DL jobs originating from the single operation requested by the operator by using the unifying ID as key information for searching for log information. Thus, the log management service 31 can transmits log information of the series of DL jobs originating from the single operation requested by the operator to the client application 21.

Hence, although plural log information items are not bound together in the example shown in the sequence diagram of FIG. 16, the plural log information items of a series of DL jobs originating from a single operation of the operator are associated by using the unifying ID in the General information 101 of the log information as an ID. Accordingly, the plural log information items of a series of DL jobs originating from a single operation of the operator can be searched for by performing the processes shown in the sequence diagram of FIG. 16. It is convenient for the operator since the log information of the series of DL jobs originating from the single operation can be distinguished (identified) in a case, for example, where stored documents are downloaded page by page (multiple DL jobs).

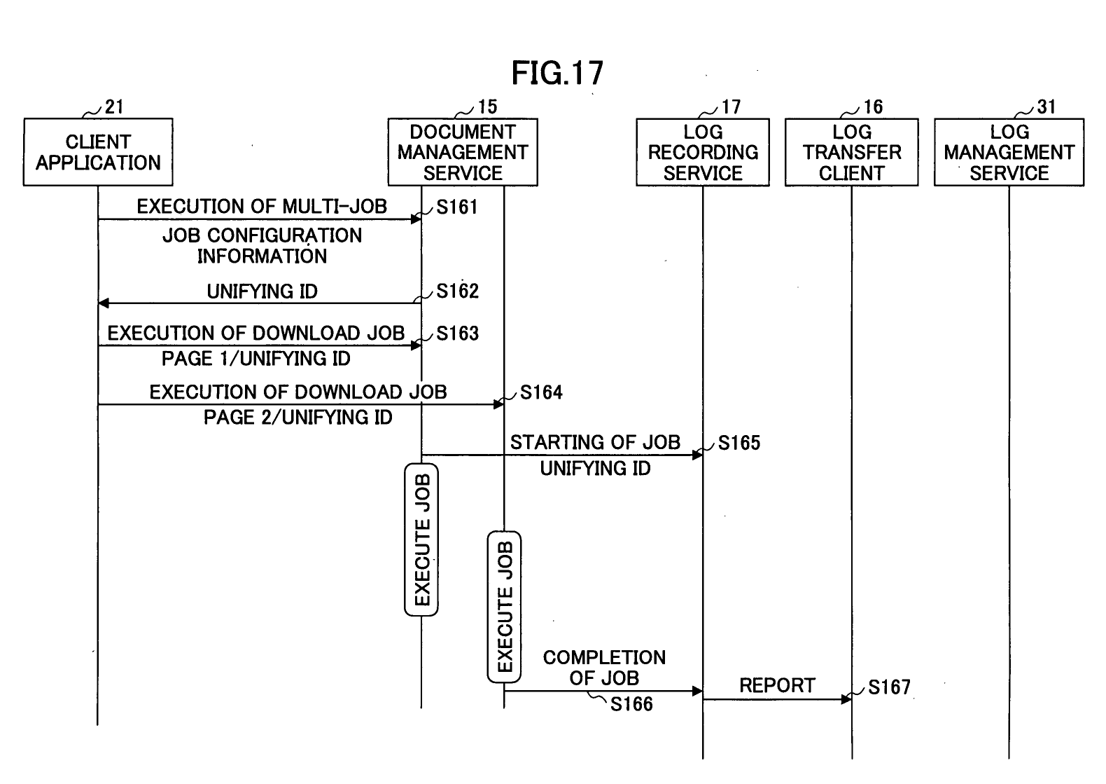

FIG. 17 is a sequence diagram showing an example of the processes of a log management system according to another embodiment of the present invention. Except for a portion of FIG. 17, like parts are denoted by like numerals as of FIGS. 3, 6, 10, 16 and are not further explained.

In Step S161, the client application 21 of the PC 2 transmits a multi-job execution request including job configuration information to the document management service 15 of the MFP 1. The job configuration information includes, for example, the number of jobs, the type of jobs, or characteristics of jobs of the series of jobs originating from the single operation requested by the operator. When the document management service 15 receives the multi-job execution request from the client application 21, the document management service 15 issues an unifying ID as an identifier for associating (relating) the series of jobs originating from a single operation requested by the operator.

Since the processes of Steps S162 to S164 are the same as those of Steps S142 to S144 of FIG. 16, explanation of the processes of Steps S162 to S164 is omitted. In Step S165, when the document management service 15 receives the DL job execution request from the client application 21, the document management service 15 transmits a DL job start report including information of the unifying ID to the log recording service 17 and executes DL jobs corresponding to the DL job execution requests of Steps S163 and S164.

In Step S166, after the completion of the execution of the DL jobs corresponding to the DL job execution requests of Steps S163 and S164, the document management service 15 binds together the log information of the two DL jobs and transmits a DL job completion report to the log recording service 17. Since the job configuration information is received by the document management service 15 in Step S161, the document management service 15 can determine that the series of jobs originating from the single operation requested by the operator corresponds to the two download jobs of DL job execution requests in Steps S163 and S164. Therefore, the document management service 15 can determine that all jobs of the series of jobs originating from the single operation requested by the operator are completed when the DL job corresponding to the DL job execution request of Step S164 is completed.

When the log recording service 17 receives the DL job completion report, the log recording service 17 records the log information of the two DL jobs executed by the document management service 15 in the log storage part 18. In Step S167, after the log information is recorded in the log storage part 18, the log recording service 17 reports that the log information of the DL jobs has been recorded in the log storage part 18 to the log transfer client 16.

Same as Steps S8 to S10 of FIG. 3, the log transfer client 16 refers to the recorded log information in correspondence with each report or each predetermined interval of time and receives log information from the log storage part 18 via the log recording service 17. Then, the log transfer client 16 transfers the log information received from the log recording service 17 to the log management service 31 of the server 3 in the form of XML data.

Hence, with the processes shown in the sequence diagram of FIG. 17, plural log information items of a series of DL jobs originating from a single operation requested by the operator can be grouped together by using the binding process. Accordingly, the plural information items for a series of DL jobs originating from a single operation of the operator can be grouped together by performing the processes shown in the sequence diagram of FIG. 17. It is convenient for the operator since log information originating from the single operation can be identified in a case, for example, where stored documents are downloaded page by page (multiple DL jobs).

### Fourth Embodiment

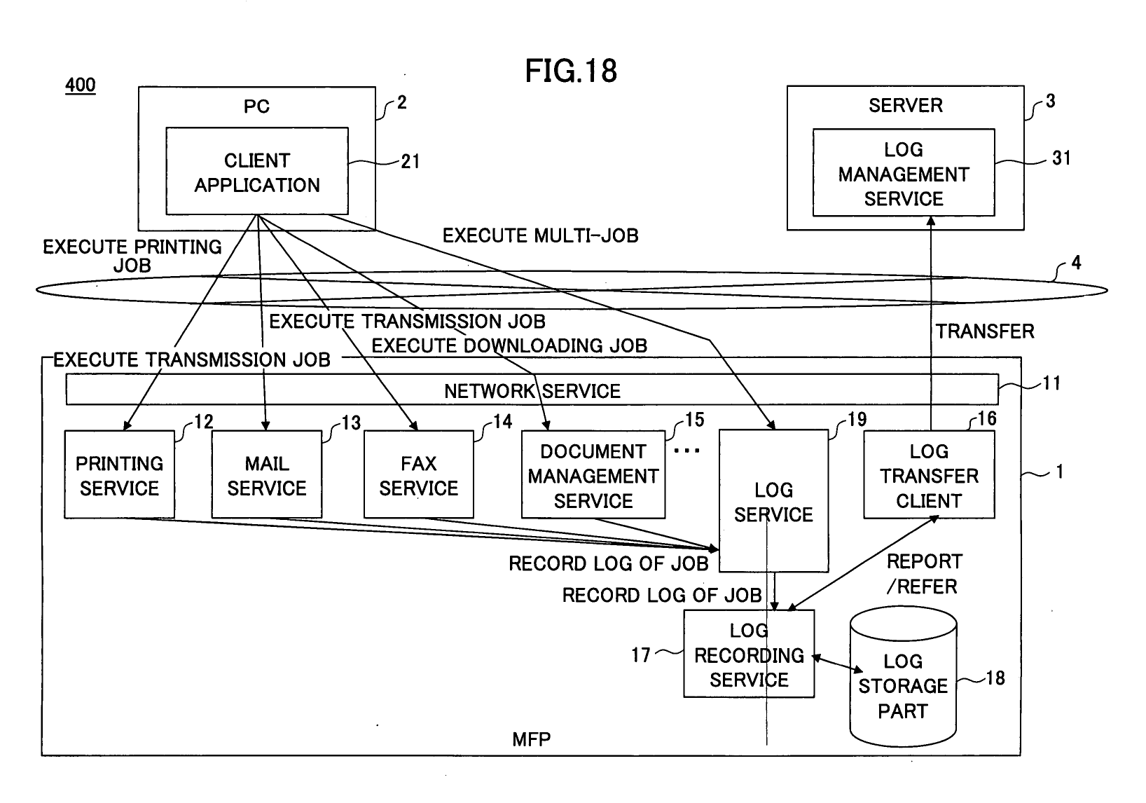

FIG. 18 is a schematic drawing showing an exemplary configuration of a log management system 400 according to another embodiment of the present invention. Except for a portion of FIG. 18, like parts are denoted by like numerals as of FIG. 2 and are not further explained. The log management system 400 shown in FIG. 18 includes a log service 19 which serves as a service module of the MFP 1.

The log management system 400 shown in FIG. 18 is different from the log management system 100 shown in FIG. 2 mainly in that the log service 19 receives log information from the service module, and that the log recording service 17 receives log information from the log service 19 and records the log information in the log storage part 18.

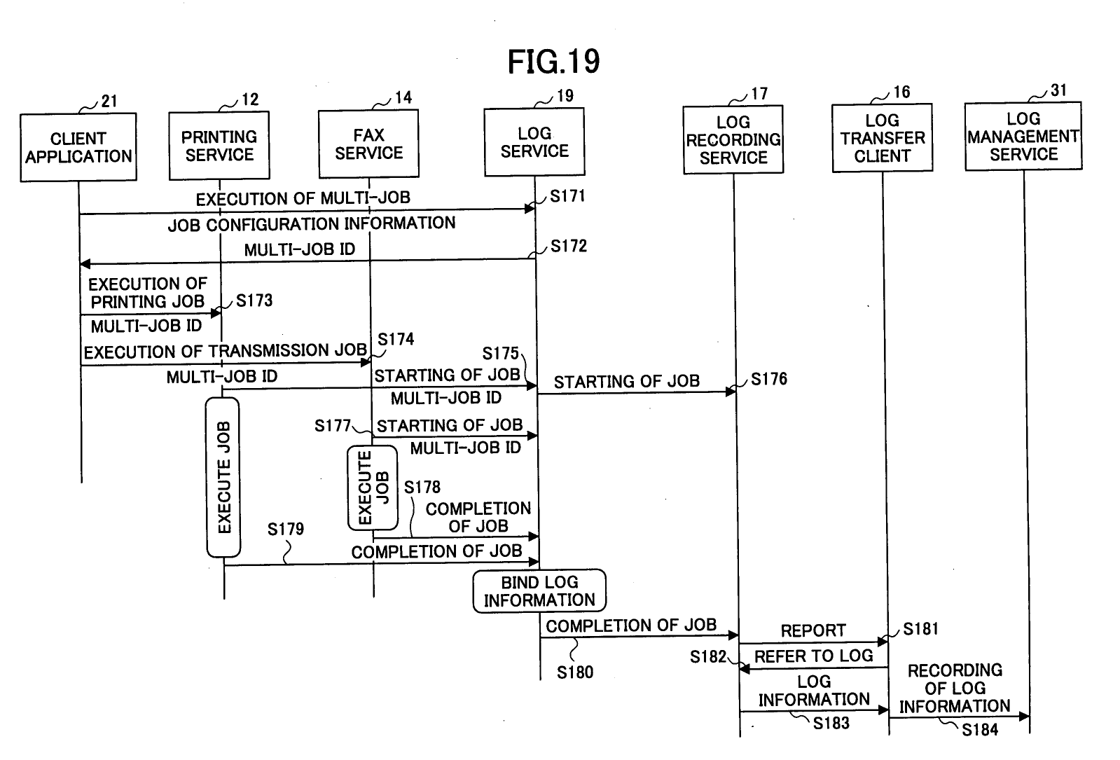

Next, the processes of the log management system 400 shown in FIG. 18 are described. FIG. 19 is a sequence diagram showing an example of the processes of a log management system according to another embodiment of the present invention. Except for a portion of FIG. 19, like parts are denoted by like numerals as of FIGS. 3, 6, 10, 12, 14, and 16 and are not further explained.

In Step S171, the client application 21 of the PC 2 transmits a multi-job execution request including job configuration information to the log service 19 of the MFP 1. When the log service 19 receives the multi-job execution request including the job configuration information, the log service 19 issues a multi-job ID as an identifier for associating (relating) the series of jobs originating from the single operation requested by the operator. In Step S172, the log service 19 transmits the multi-job ID to the client application 21 of the PC 2.

In Step S173, the client application 21 transmits a printing job execution request including information of the multi-job ID to the printing service 12 of the MFP 1. In Step S174, the client application 21 transmits a transmission job execution request including information of the multi-job ID to the fax service 14 of the MFP 1.

In Step S175, when the printing service 12 receives the printing job execution request from the client application 21, the printing service 12 transmits a printing job start report including the information of the multi-job ID to the log service 19 and then executes a printing job. In Step S176, when the log service 19 receives the printing job start report including the information of the multi-job ID, the log service 19 transmits a job start report to the log recording service 17.

In Step S177, when the fax service 14 receives a transmission job execution request from the client application 21, the fax service 14 transmits a transmission job start report including information of the multi-job ID to the log service 19 and then executes a transmission job.

In Step S178, when the fax transmission job is completed, the fax service 14 transmits a transmission job completion report to the log service 19. In Step S179, when the printing job is completed, the printing service 12 transmits a printing job completion report to the log service 19.

Since the log service 19 receives the job configuration information in Step S171 and receives the information of the multi-job ID in Steps S175 and S177, the log service 19 can determine the series of jobs originating from the single operation requested by the operator correspond to the printing job executed by the printing service 12 and the transmission job executed by the fax service 14.

Therefore, when the log service 19 receives the transmission job completion report in Step S178 and the printing job completion report in Step S179, the log service 19 can determine that all jobs of the series of jobs originating from the single operation requested by the operator are completed.

When the log service 19 determines that all jobs of the series of jobs originating from the single operation requested by the operator are completed, the log service binds together the log information of the printing job executed by the printing service 12 and the log information of the transmission job executed by the transmission service 14.

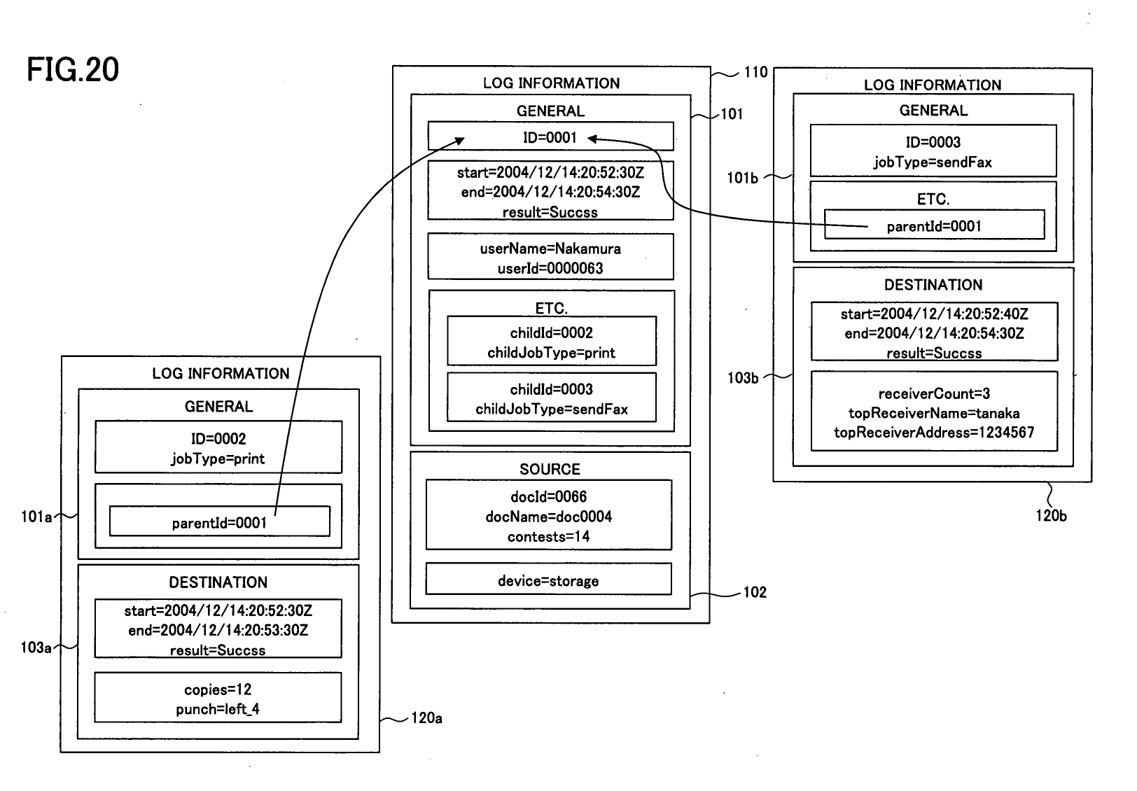

FIG. 20 is a schematic drawing showing an exemplary configuration of plural log information items that are bound together. The log information of FIG. 20 includes common log information (i.e. log information that is commonly shared among the series of jobs) 110, and respective log information items (i.e. log information corresponding to each job) 120a, 120b.

The common log information 110 includes General information 101 and Source information 102. The respective information 120a item includes General information 101a and Destination information 103a. The respective information 120b includes General information 101b and Destination information 103b.

The common log information 110 includes, for example, information that is commonly shared among the series of jobs originating from a single operation requested by the operator. The respective log information items 120a, 120b include, for example, log information of each printing job executed by the printing service 12 and each transmission job executed by the fax service 14, respectively.

The General information 101 of the common log information 110 includes, for example, overall information of a series of jobs originating from a single operation requested by the operator the Source information 102 of the common log information 110 includes, for example, information of the object that is to be operated (handled) by the service module.

The General information items 101a, 101b of the respective log information items 120a, 120b include, for example, overall information of a single job. The Destination information items 103a, 103b of the respective log information items 120a, 120b include, for example, information of the object operated (handled) by the service module.

The common log information 110 and the respective log information items 120a, 120b are associated (related) by having the ID included in the General information 101 of the common log information 110 associated with the ID included in the General information items 101a, 101b of the respective log information items 120a, 120b. The log service 19 binds together the log information of the printing job executed by the printing service 12 and the log information of the transmission job executed by the transmission service 14 (as shown in FIG. 20).

In Step S180, the log service 19 transmits a job completion report to the log recording service 17. When the log recording service 17 receives the job completion report, the log recording service 17 records the log information bound by the log service 19 in the log storage part 18. In Step S181, the log recording service 17 reports that the log information has been recorded in the log storage part 18 to the log transfer client 16.

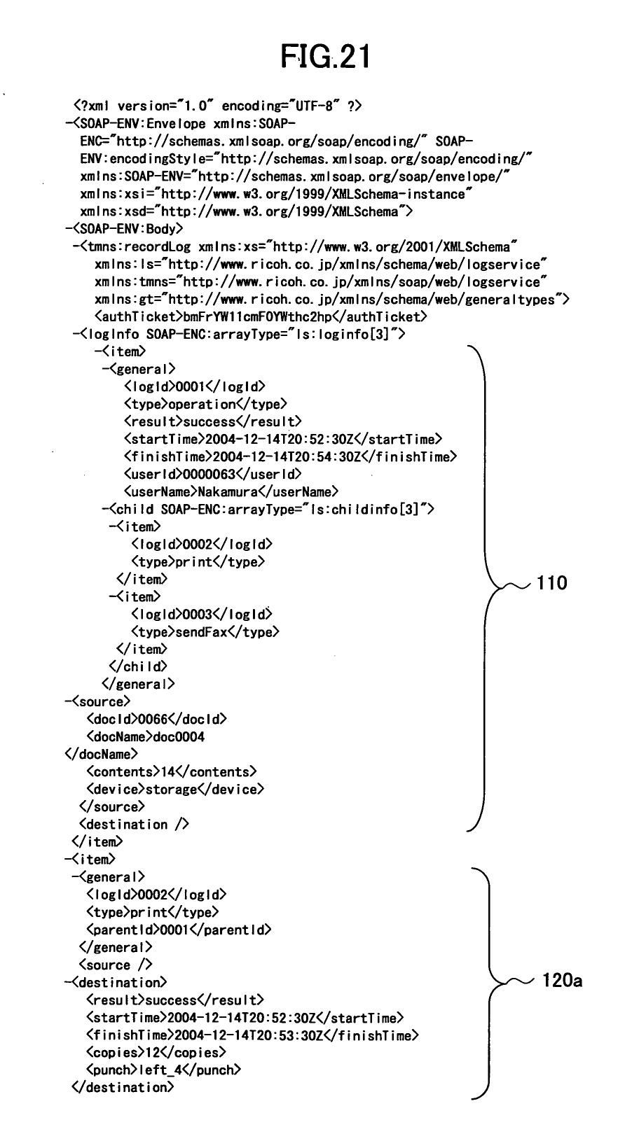

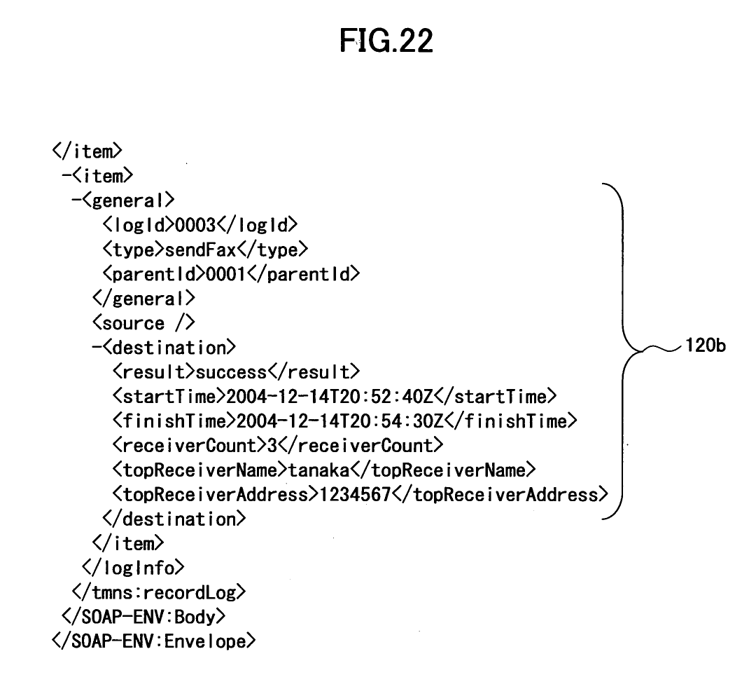

The same as Steps S112 to S114 of FIG. 12, the log transfer client 16 refers to the recorded log information in correspondence with each report or each predetermined interval of time and receives log information from the log storage part 18 via the log recording service 17. Then, the log transfer client 16 transfers the log information received from the log recording service 17 to the log management service 31 of the server 3 in the form of XML data shown in, for example, FIG. 21 or FIG. 22.

FIGS. 21 and 22 show exemplary configurations of XML data in a case of transferring bound log information to the server 3. In a manner similar to the bound data of FIG. 20, the XML data shown in FIGS. 21 and 22 is provided with the common log information 110, the respective log information 120a indicative of the log information of the printing job executed by the printing service 12, and the respective log information 120b indicative of the log information of the transmission job executed by the fax service 14.

The log management service 31 extracts log information from the XML data (shown in FIGS. 21 and 22) transferred from the log transfer client 16 of the MFP 1 and records the extracted log information in, for example, a HDD, to thereby manage the log information.

Hence, with the processes shown in the sequence diagram of FIG. 19, plural log information items of a series of jobs originating from a single operation requested by the operator can be associated (related) by using the binding process. Accordingly, the plural information items of a series of jobs originating from a single operation of the operator can be associated by performing the processes shown in the sequence diagram of FIG. 19. It is convenient for the operator since log information originating from the single operation can be identified.

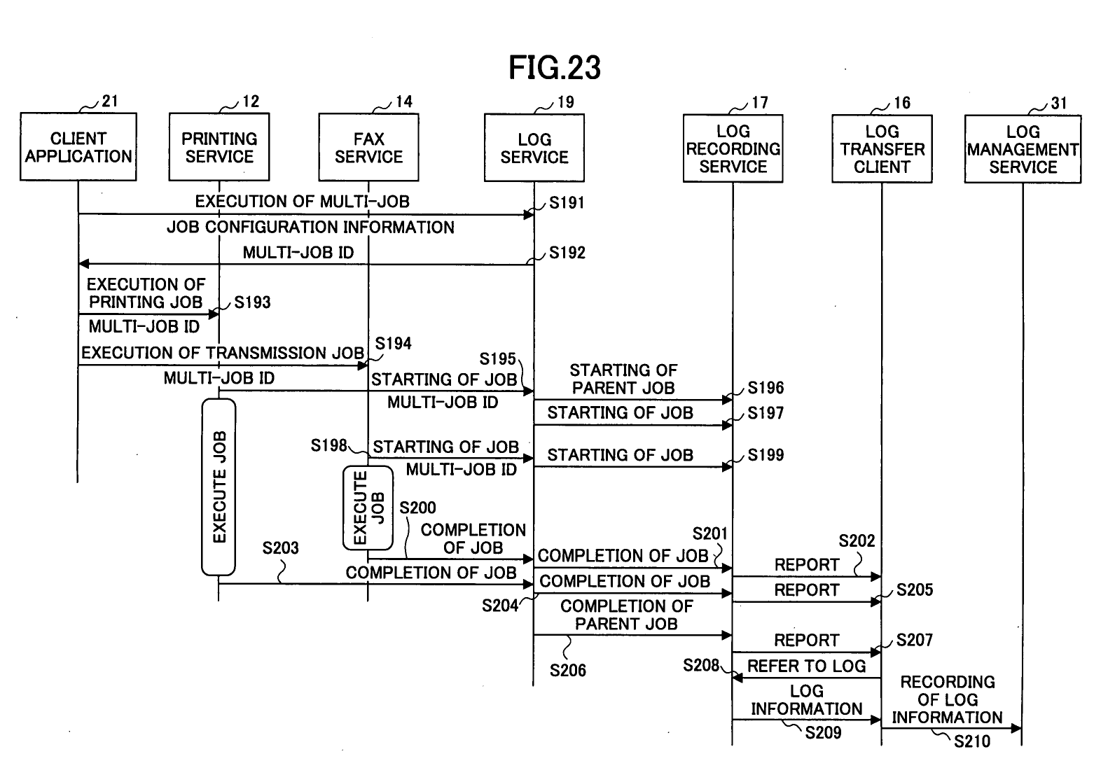

FIG. 23 is a sequence diagram showing an example of the processes of a log management system according to another embodiment of the present invention. Except for a portion of FIG. 23, like parts are denoted by like numerals as of FIGS. 3, 6, 10, 12, 14, 16, and 19 and are not further explained. The processes of Steps S191 to S195 are the same as those of Steps S171 to S175 of FIG. 19.

In Step S196, when the log service 19 receives a printing job start report including information of a multi-job ID, the log service 19 transmits a parent job start report to the log recording service 17. In Step S197, the log service 19 transmits a printing job start report to the log recording service 17. In Step S198, when the fax service 14 receives a transmission job execution request from the client application 21, the fax service 14 transmits a transmission job start report including information of a multi-job ID to the log service 19 and then executes a transmission job. In Step S199, the log service 19 transmits a transmission job start report to the log recording service 17.

In Step S200, after the completion of the fax transmission job, the fax service 14 transmits a transmission job completion report to the log service 19. In Step S201, log service 19 transmits a transmission job completion report to the log recording service 17.

When the log recording service 17 receives the transmission job completion report, the log recording service 17 records the log information of the transmission job executed by the fax service 14 in the log storage part 18. In Step S202, the log recording service 17 reports that the log information of the transmission job has been recorded in the log storage part 18 to the log transfer client 16.

In Step S203, when the printing job is completed, the printing service 12 transmits a printing job completion report to the log service 19. In Step S204, the log service 19 transmits a printing job completion report to the log recording service 17.

When the log recording service 17 receives the printing job completion report, the log recording service 17 records the log information of the printing job executed by the printing service 12 in the log storage part 18. In Step S205, the log recording service 17 reports that the log information of the printing job has been recorded in the log storage part 18 to the log transfer client 16.

Since the log service 19 receives the job configuration information in Step S191 and receives the information of the multi-job ID in Steps S195 and S196, the log service 17 can determine that the series of jobs originating from the single operation of the operator correspond to the printing job executed by the printing service 12 and the transmission job executed by the fax service 14.

Accordingly, when the log service 19 receives the transmission job completion report in Step S200 and the printing job completion report in Step S203, the log service 19 can determine that all of the series of jobs originating from the single operation requested by the operator are completed.

In Step S206, when the log service 19 determines that all of the series of jobs originating from the single operation requested by the operator are completed, the log service 19 transmits a parent job completion report to the log recording service 17. In Step S207, the log recording service 17 reports that the log information has been recorded to the log transfer client 16.

The same as Steps S112 to S114 of FIG. 12, the log transfer client 16 refers to the recorded log information in correspondence with each report or each predetermined interval of time and receives log information from the log storage part 18 via the log recording service 17. Then, the log transfer client 16 transfers the log information received from the log recording service 17 to the log management service 31 of the server 3 in the form of XML data shown in, for example, FIG. 21 or FIG. 22.

The log management service 31 extracts log information from the XML data (shown in FIGS. 21 and 22) transferred from the log transfer client 16 of the MFP 1 and records the extracted log information in, for example, a HDD, to thereby manage the log information.

Hence, with the processes shown in the sequence diagram of FIG. 23, plural log information items of a series of jobs originating from a single operation requested by the operator can be grouped together by using the binding process. Accordingly, the plural information items of a series of jobs originating from a single operation of the operator can be associated (related) by performing the processes shown in the sequence diagram of FIG. 23. It is convenient for the operator since log information originating from the single operation can be identified.

### Fifth Embodiment

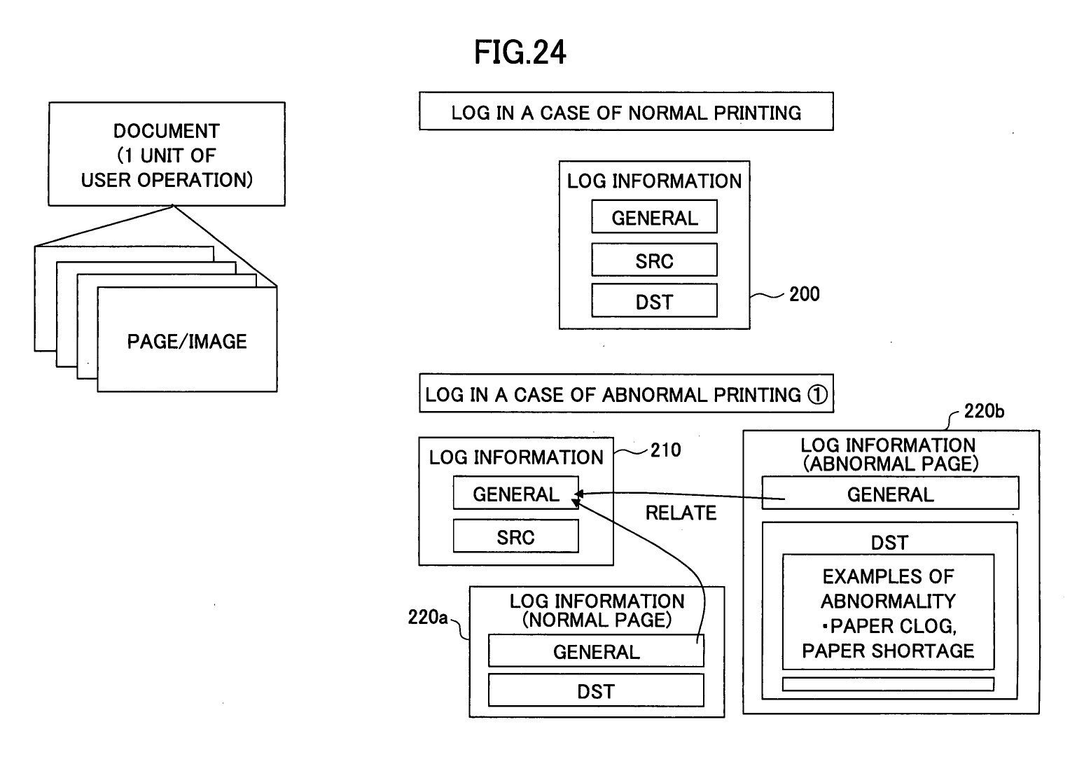

Although plural log information items of a series of jobs originating from a single operation requested by the operator are not bound in a case where a job is ended due to an abnormality (abnormal end) according to the sequence diagram shown in FIGS. 6 and 14, plural information items may also be bound in a manner shown in FIG. 24.

FIG. 24 is a schematic diagram showing an exemplary case where log information of a job completed (ended) without any abnormality (normal end) and log information of another job ended with abnormality (abnormal end) are bound together. In the exemplary case shown in FIG. 24, a stored document is printed page by page by executing a series of printing jobs.

For example, in a case where all of the series of printing jobs originating from a single operation of the operator are completed without any abnormality, the log information items of all of the printing jobs are bound together as a single log information item. Meanwhile, in a case where at least one job in the series of printing jobs originating from a single operation of the operator is ended due to abnormality (abnormal end), common log information 210, log information of a printing job completed without any abnormality, and log information of a printing job ended due to abnormality are bound together by being associated (related) with each other.

Accordingly, in addition to associating (relating) plural log information items of a series of jobs originating from a single operation requested by the operator, it can be determined whether the jobs are completed (ended) with or without an abnormality. Therefore, it is convenient for the operator since the operator not only can determine (distinguish) the log information of the jobs originating from a single operation requested by the operator, but can also determine whether the jobs are completed (ended) with or without an abnormality.

(Referring of Log Information)

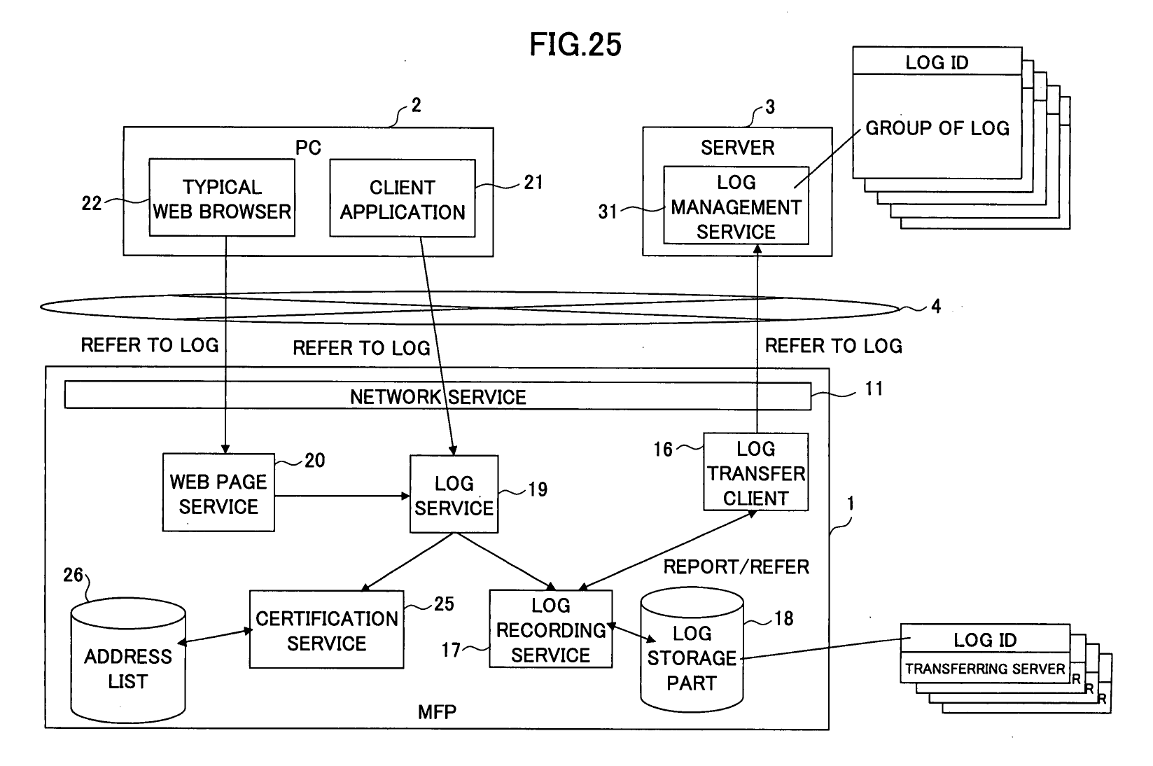

Reference can be made to the log information recorded in the server in accordance with the above-described first to fifth embodiments of the present invention as exemplary shown FIG. 25. FIG. 25 is a schematic diagram showing an exemplary process of referring to the log information.

In the PC 2, the client application 21 and a typical Web browser 22 are activated for receiving a request from an operator requesting reference to log information recorded in a server. The client application 21 transmits the log information reference request to the log service 19. The Web browser 22 transmits the log information reference request to the log service 19 via a Web page service 20 of the MFP 1.

The log service 19 requests a verification service (certification service) 25 to perform a verification process with respect to the operator of the PC 2. The request may be made according to necessity. The verification service 25 verifies the operator by using the address list 26. When the verification process is completed normally (successfully), the log service 19 transmits a log information reference request to the log recording service 17. The log recording service 17 identifies the server 3 by which the log information is transferred by referring to a matching list indicative of log information and log IDs serving as identifiers of the log information recorded in the log storage part 18.

The log recording service 17 receives log information from the log management service 31 of the identified server 3 via the log transfer client 16. Then, the log recording service 17 transmits the received log information to the client application 21 and/or the Web browser in the PC 2. Accordingly, the operator of the PC 2 can refer to the log information recorded in the server 3.

The log information recorded in the server 3 is associated to a series of jobs originating from a single operation requested by the operator according to the above-described first to fifth embodiments of the present invention. Therefore, it is convenient for the operator since log information originating from a single operator of the operator can be distinguished.

Further, the present invention is not limited to these embodiments, but variations and modifications may be made without departing from the scope of the present invention.

The present application is based on Japanese Priority Application No. 2005-024189 filed on Jan. 31, 2005, with the Japanese Patent Office, the entire contents of which are hereby incorporated by reference.

What is claimed is:

1. An image processing apparatus for performing an image forming process, the image processing apparatus comprising:
one or more job executing parts for executing a series of jobs for performing the image forming process; and
a log recording part for recording a plurality of log information items corresponding to the series of jobs executed by the one or more job executing parts;
wherein the plural log information items are recorded in association with the image forming process.

2. The image processing apparatus as claimed in claim 1, wherein the plural log information items recorded in association with the image forming process are bound together.

3. The image processing apparatus as claimed in claim 1, wherein the plural log information items recorded in association with the image forming process have the same identifier.

4. The image processing apparatus as claimed in claim 1, wherein the plural log information items recorded in association with the image forming process include common log information containing information that is commonly shared by the series of jobs and individual log information containing information of each job, wherein the common log information is associated with the individual log information.

5. An image processing apparatus for performing an image forming process, the image processing apparatus comprising:
one or more job executing parts for executing a series of jobs for performing the image forming process; and
a log recording part for receiving a plurality of log information items corresponding to the series of jobs from the one or more job executing parts, binding together the plural log information items, and recording the bound plural log information items in association with the image forming process.

6. The image processing apparatus as claimed in 5, wherein the plural log information items are recorded without being bound together in a case where an abnormal end occurs in one of the jobs in the series of jobs.

7. An image processing apparatus for performing an image forming process, the image processing apparatus comprising:
one or more job executing parts for executing a series of jobs for performing the image forming process;
a log recording part for receiving a plurality of log information items corresponding to the series of jobs from the one or more job executing parts, binding together the plurality of log information items, and recording the bound plural log information items in association with the image forming process; and
a log integration part for requesting the log recording part to bind together the plural log information items and record the bound plural log information items in association with the image forming process.

8. The image processing apparatus as claimed in 7, wherein the plural log information items are recorded without being bound together in a case where an abnormal end occurs in one of the jobs in the series of jobs.

9. An image processing apparatus for performing an image forming process, the image processing apparatus comprising:
a job executing part for executing a series of jobs for performing the image forming process and binding together a plurality of log information items corresponding to the series of jobs; and
a log recording part for receiving the bound plural log information items from the job executing part and recording the bound plural log information items.

10. An image processing apparatus for performing an image forming process, the image processing apparatus comprising:
one or more job executing parts for executing a series of jobs for performing the image forming process;
a log integration part for receiving a plurality of log information items corresponding to the series of jobs from the one or more job executing parts and binding together the plural log information items; and
a log recording part for receiving the bound plural log information items from the log integration part and recording the bound plural log information items.

11. An image processing apparatus for performing an image forming process, the image processing apparatus comprising:
one or more job executing parts for executing a series of jobs for performing the image forming process;
a log integration part for receiving a plurality of log information items corresponding to the series of jobs from the one or more job executing parts and making a request to bind together the plural log information items and transfer the bound plural log information items;
a log recording part for receiving the plural log information items from the log integration part and recording the plural log information items; and
a log transferring part for binding together the plural log information items in accordance with the request of the log integration part and transferring the bound plural log information items to a predetermined log management apparatus.

12. The image processing apparatus as claimed in claim 1, wherein the plural log information items recorded in association with the image forming process are available for reference in accordance with a request by an operator of the image processing apparatus.

13. The image processing apparatus as claimed in claim 1, wherein the plural log information items recorded in association with the image forming process include common log information containing information that is commonly shared by the series of jobs and individual log information containing information of each job, wherein the common log information is associated with the individual log information, wherein the individual log information is divided into log information corresponding to a successfully ended job and log information corresponding to an abnormally ended job.

14. An image processing apparatus connected to a terminal that is operated by an operator and a log management apparatus that manages log information, the image processing apparatus being connected to the terminal and the log management apparatus via a predetermined network, the image processing apparatus comprising:
a receiving part for receiving a request to perform an image forming process from the terminal;
one or more job executing parts for executing a series of jobs for performing the image forming process; and
a transferring part for transferring a plurality of log information items corresponding to the series of jobs to the log management apparatus;
wherein the plural log information items are transferred in association with the image forming process.

15. A log management method for an image processing apparatus performing an image forming process, the method comprising the steps of:
executing a series of jobs for performing the image forming process; and
recording a plurality of log information items corresponding to the series of jobs in association with the image forming process.

16. The log management method as claimed in claim 15, wherein the plural log information items recorded in association with the image forming process are bound together.

17. The log management method as claimed in claim 15, wherein the plural log information items recorded in association with the image forming process have the same identifier.

18. The log management method as claimed in claim 15, wherein the plural log information items recorded in association with the image forming process include common log information containing information that is commonly shared by the series of jobs and individual log information containing information of each job, wherein the common log information is associated with the individual log information.

19. A log management system including an image processing apparatus connected to a terminal that is operated by an operator and a log management apparatus that manages log information, the image processing apparatus being connected to the terminal and the log management apparatus via a predetermined network, the image processing apparatus comprising:
a receiving part for receiving a request to perform an image forming process from the terminal;
one or more job executing parts for executing a series of jobs for performing the image forming process; and
a transferring part for transferring a plurality of log information items corresponding to the series of jobs to the log management apparatus;
wherein the plural log information items are transferred in association with the image forming process.
